(19) United States
(12) Patent Application Publication
(10) Pub. No.: US 2026/0179539 A1
(43) Pub. Date: Jun. 25, 2026

(54) LIGHT EMITTING DISPLAY APPARATUS

(71) Applicants: LG Display Co., Ltd., Seoul (KR); SNU R&DB FOUNDATION, Seoul (KR)

(72) Inventors: KeyYoung Yang, Paju-si (KR); MoonSeok Jung, Paju-si (KR); SangHee Yu, Paju-si (KR); Soo-Yeon Lee, Seoul (KR)

(73) Assignees: LG Display Co., Ltd., Seoul (KR); SNU R&DB FOUNDATION, Seoul (KR)

(21) Appl. No.: 19/402,336

(22) Filed: Nov. 26, 2025

(30) Foreign Application Priority Data
Dec. 19, 2024 (KR) 10-2024-0190952

(51) Int. Cl. G09G 3/32

(52) U.S. Cl. CPC G09G 3/32; G09G 2300/0842; G09G 2310/0267; G09G 2310/0286; G09G 2320/045

(57) ABSTRACT

A light emitting display apparatus according to an embodiment of the present disclosure comprises a light emitting display panel including pixels and stages configured to supply scan signals to the pixels, respectively, wherein each of the stages starts to be driven by a start pulse and outputs a scan pulse having a pulse width identical to a pulse width of the start pulse.

### CROSS-REFERENCE TO RELATED APPLICATION

This application claims priority to Korean Patent Application No. 10-2024-0190952, filed in the Republic of Korea on Dec. 19, 2024, the entirety of which is hereby incorporated by reference into the present application as if fully set forth herein.

### BACKGROUND

### Field of the Disclosure

The present disclosure relates to a light emitting display apparatus.

### Discussion of the Related Art

Light emitting display apparatuses are mounted on or provided in electronic products such as televisions, monitors, notebook computers, smart phones, tablet computers, electronic pads, wearable devices, smart watch, portable information devices, navigation devices, vehicle control display devices, etc., to display images. Pixels are provided in a light emitting display panel configuring a light emitting display apparatus, and a light emitting device is provided in each of the pixels.

A gate driver is provided in the light emitting display apparatus to supply scan pulses to pixels.

In the light emitting display apparatus, scan pulses having a long pulse width may be used, or scan pulses having a short pulse width may be used.

However, in the related art, in order to generate scan pulses having a long pulse width and scan pulses having a short pulse width, stages having different structures had to be used. As a result, the manufacturing process of the light emitting display apparatus may become complicated, and the manufacturing cost of the light emitting display apparatus may increase.

### SUMMARY

Accordingly, the present disclosure is directed to a light emitting display apparatus that substantially obviates one or more problems due to limitations and disadvantages of the related art.

An aspect of the present disclosure is directed to providing a light emitting display apparatus in which a pulse width of a scan pulse can be changed by a pulse width of a start pulse.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other advantages and in accordance with the purpose of the disclosure, as embodied and broadly described herein, a light emitting display apparatus includes light emitting display panel including pixels and stages configured to supply scan signals to the pixels, respectively, wherein each of the stages starts to be driven by a start pulse and outputs a scan pulse having a pulse width identical to a pulse width of the start pulse.

It is to be understood that both the foregoing general description and the following detailed description of the present disclosure are by way of example and explanatory and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain various principles of the disclosure. In the drawings:

FIG. 1 is an example diagram illustrating a configuration of a light emitting display apparatus according to an example embodiment of the present disclosure;

FIG. 2 is an example diagram illustrating a structure of a pixel applied to a light emitting display apparatus according to an example embodiment of the present disclosure;

FIG. 3 is an example diagram illustrating a structure of a control driver applied to a light emitting display apparatus according to an example embodiment of the present disclosure;

FIG. 4 is an example diagram illustrating a structure of a data driver applied to a light emitting display apparatus according to an example embodiment of the present disclosure;

FIG. 5 is an example diagram illustrating a structure of a gate driver applied to a light emitting display apparatus according to an example embodiment of the present disclosure;

FIGS. 6A and 6B are example diagrams illustrating a structure of a stage applied to a light emitting display apparatus according to an example embodiment of the present disclosure;

FIG. 7 is an example diagram illustrating signals supplied to a stage applied to a light emitting display apparatus according to an example embodiment of the present disclosure and signals generated from the stage;

FIGS. 8 to 13 are example diagrams for explaining a method of operating the stage illustrated in FIG. 6A;

FIG. 14 is an example diagram for describing a function of a start unit applied to a light emitting display apparatus according to an example embodiment of the present disclosure;

FIG. 15 is an example diagram for describing a function of an inverting unit applied to a light emitting display apparatus according to an example embodiment of the present disclosure;

FIG. 16 is another example diagram illustrating signals supplied to a stage applied to a light emitting display apparatus according to an example embodiment of the present disclosure and signals generated from the stage;

FIGS. 17 and 18 are other example diagrams illustrating the structure of a stage applied to a light emitting display apparatus according to an example embodiment of the present disclosure; and

FIGS. 19A to 19D and 20A to 20D are example diagrams illustrating start signals and scan signals applied to a light emitting display apparatus according to an example embodiment of the present disclosure.

### DETAILED DESCRIPTION

Reference will now be made in detail to the example embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following example embodiments described with reference to the accompanying drawings. The present disclosure can, however, be embodied in different forms and should not be construed as limited to the example embodiments set forth herein. Rather, these example embodiments are provided so that this disclosure will be more thorough and complete, and will more fully convey the scope of the present disclosure to those skilled in the art.

A shape, a size, a ratio, an angle, and a number disclosed in the drawings for describing example embodiments of the present disclosure are merely examples, and the present disclosure is thus not limited to the illustrated details. Like reference numerals refer to like elements throughout unless otherwise specified. In the following description, where the detailed description of the relevant known function or configuration may unnecessarily obscure an aspect or feature of the present disclosure, such detailed description may be omitted. Where terms like “comprise,” “have,” and “include” are used in the present disclosure, another part can be added unless a more specific term like “only” is used. The terms of a singular form can include plural forms, and vice versa, unless referred to the contrary.

In construing an element, the element is to be construed as including an error or tolerance range even where there is no explicit description of such an error or tolerance range.

In describing a position relationship, for example, where a position relation between two parts is described as, for example, “on,” “over,” “under,” and “next,” one or more other parts can be disposed between the two parts unless a more limiting term, such as “just” or “direct(ly),” is used.

In describing a time relationship, for example, where the temporal order is described as, for example, “after,” “subsequent,” “next,” and “before,” a situation that is not continuous can be included unless a more limiting term, such as “just,” “immediate(ly),” or “direct(ly),” is used.

It should be understood that, although such terms as “first,” “second,” etc., can be used herein to describe various elements, these elements should not be limited by these terms. These terms are only used to refer to one element separately from another. For example, a first element could be termed a second element, and similarly, a second element could be termed a first element, without departing from the scope of the present disclosure.

In describing elements of the present disclosure, such terms as “first,” “second,” “A,” “B,” “(a),” “(b),” etc., can be used. These terms are intended to identify the corresponding elements separately from the other elements, and the basis, order, or number of the corresponding elements should not be limited by these terms. The expression that an element is “connected,” “coupled,” or “adhered” to another element or layer the element or layer can encompass not only being directly connected or adhered to another element or layer, but also being indirectly connected or adhered to another element or layer with one or more intervening elements or layers “disposed” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item, as well as the first item, the second item, or the third item individually. Also, the term “can” used herein can include all meanings and definitions of the term “may.”

Features of various embodiments of the present disclosure can be partially or wholly coupled to or combined with each other, and can be variously inter-operated with each other and driven technically as those skilled in the art can sufficiently understand. The embodiments of the present disclosure can be carried out independently from each other or can be carried out together in co-dependent relationship.

Hereinafter, example embodiments of the present disclosure will be described in detail with reference to the accompanying drawings.

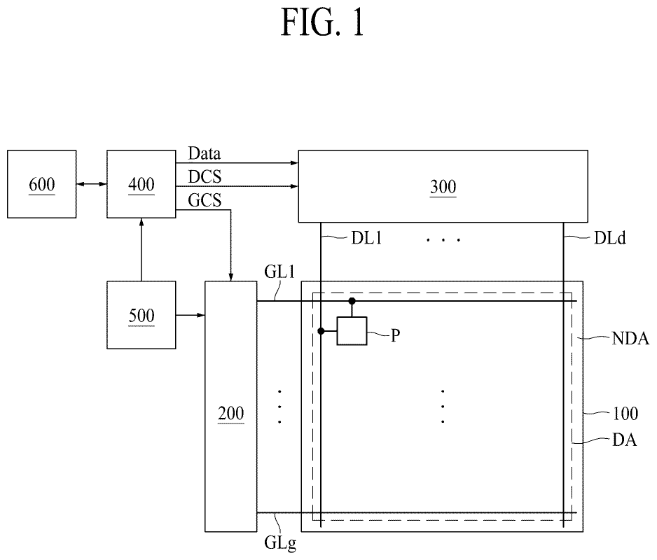

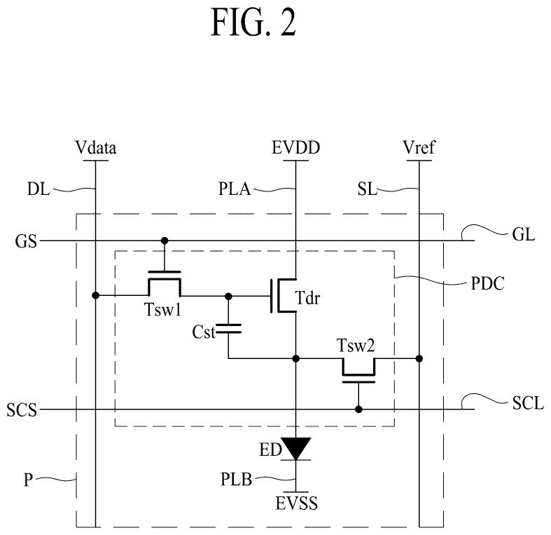

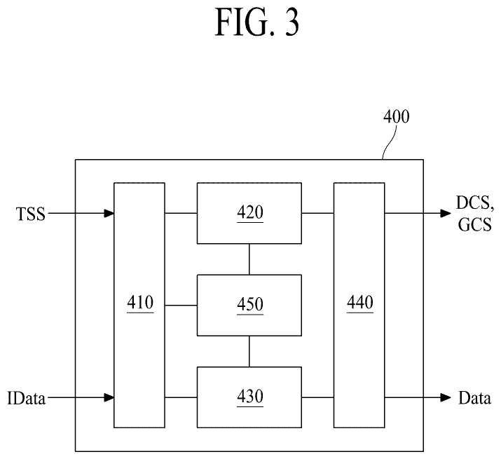

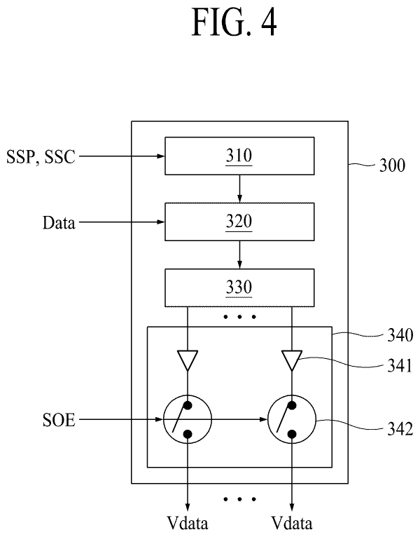

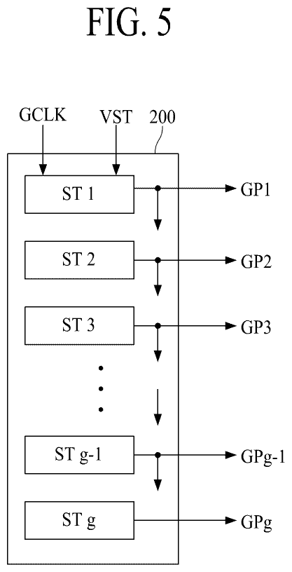

FIG. 1 is an example diagram illustrating a configuration of a light emitting display apparatus according to an example embodiment of the present disclosure, FIG. 2 is an example diagram illustrating a structure of a pixel applied to a light emitting display apparatus according to an example embodiment of the present disclosure, FIG. 3 is an example diagram illustrating a structure of a control driver applied to a light emitting display apparatus according to an example embodiment of the present disclosure, FIG. 4 is an example diagram illustrating a structure of a data driver applied to a light emitting display apparatus according to an example embodiment of the present disclosure, and FIG. 5 is an example diagram illustrating a structure of a gate driver applied to a light emitting display apparatus according to an example embodiment of the present disclosure;

A light emitting display apparatus according to an example embodiment of the present disclosure can be used in various kinds of electronic devices. Electronic devices can be, for example, televisions, monitors, etc.

The light emitting display apparatus according to an example embodiment of the present disclosure, as illustrated in FIG. 1, can include a light emitting display panel 100 which includes a display area DA displaying an image and a non-display area NDA provided outside the display area DA, a gate driver 200 which supplies gate signals GS to a plurality of gate lines GL1 to GLg provided in the display area DA of the display panel 100, a data driver 300 which supplies data voltages Vdata to a plurality of data lines DL1 to DLd provided in the display area DA of the display panel 100, a control driver 400 which controls driving of the gate driver 200 and the data driver 300, and a power supply unit 500 which supplies power to the control driver 400, the gate driver 200, the data driver 300, and the light emitting display panel 100.

First, the light emitting display panel 100 can include a display area DA and a non-display area NDA. Gate lines GL1 to GLg, data lines DL1 to DLd, and pixels P can be provided in the display area DA. Accordingly, an image can be displayed in the display area DA. Here, g and d are natural numbers. The non-display area NDA can surround the outer periphery of the display area DA.

The pixel P included in the light emitting display panel 100, as illustrated in FIG. 2, can include a pixel driving circuit PDC which includes a switching transistor Tsw1, a storage capacitor Cst, a driving transistor Tdr, and a sensing transistor Tsw2, and a light emitting device ED connected to the pixel driving circuit PDC.

A first terminal of the driving transistor Tdr can be connected to a first voltage supply line through which a first voltage EVDD is supplied, and a second terminal of the driving transistor Tdr can be connected to the light emitting device ED.

A first terminal of the switching transistor Tsw1 can be connected to a data line DL, a second terminal of the switching transistor Tsw1 can be connected to a gate of the driving transistor Tdr, and a gate of the switching transistor Tsw1 can be connected to a gate line GL.

A data voltage Vdata can be supplied through the data line DL from the data driver 300. A gate signal GS can be supplied through the gate line GL from the gate driver 200. The gate signal GS can include a gate pulse GP for turning on the switching transistor Tsw1 and a gate-off signal for turning off the switching transistor Tsw1.

The sensing transistor Tsw2 can be provided for measuring a threshold voltage of the driving transistor Tdr or mobility of an electrical charge (e.g., an electron), or supplying a reference voltage Vref to the pixel driving circuit PDC. A first terminal of the sensing transistor Tsw2 can be connected to the second terminal of the driving transistor Tdr and the light emitting device ED, a second terminal of the sensing transistor Tsw2 can be connected to a sensing line SL through which the reference voltage Vref is supplied, and a gate of the sensing transistor Tsw2 can be connected to a sensing control line SCL through which a sensing control signal SCS is supplied.

The sensing control signal SCS can include a sensing pulse capable of turning on the sensing transistor Tsw2 and a sensing off signal capable of turning off the sensing transistor Tsw2.

The sensing line SL can be connected to the data driver 300 and can be connected to the power supply unit 500 through the data driver 300. For example, the reference voltage Vref supplied from the power supply unit 500 can be supplied to the pixels through the sensing line SL, sensing signals transmitted from the pixels P can be converted into digital sensing signals in the data driver 300, and the digital sensing signals can be transmitted to the control driver 400.

The light emitting device ED can include a first electrode supplied with a first voltage EVDD through the driving transistor Tdr, a second electrode connected to a second voltage supply line PLB through which a second voltage is supplied, and a light emitting layer provided between the first electrode and the second electrode. The first electrode can be an anode and the second electrode can be a cathode.

The structure of the pixel P applied to a light emitting display apparatus according to an example embodiment of the present disclosure is not limited to the structure illustrated in FIG. 2. Accordingly, the structure of the pixel P can be changed to various shapes according to design implementation.

The control driver 400 can realign input data signals IData transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control driver 400 can include a data aligner 430 which realigns input data signals IData to generate data signal Data, a control signal generator 420 which generates the gate control signal GCS and the data control signal DCS by using the timing synchronization signal TSS, an input unit 410 which transmits the timing synchronization signal TSS transmitted from the external system 600 to the control signal generator 420 and transmits the input data signals IData transmitted from the external system 600 to the data aligner 430, and an output unit 440 which supplies the data driver 300 with the data signal Data generated by the data aligner 430 and the data control signal DCS generated by the control signal generator 420 and supplies the gate driver 200 with the gate control signal GCS generated by the control signal generator 420.

The control signal generator 420 can generate a power control signal supplied to the power supply unit 500.

The control driver 400 can further include a storage unit for storing various kind of information. The storage unit 450 can be included in the control driver 400 as illustrated in FIG. 3, but can be separated from the control driver 400 and provided independently.

The external system 600 can perform a function of driving the control driver 400 and an electronic device.

For example, when the electronic device is a television (TV), the external system 600 can receive various kinds of sound information and image information over a communication network and can transmit the received image information to the control driver 400. For example, the external system 600 can convert the image information into input data signals IData and transmit the input data signals IData to the control driver 400.

The power supply unit 500 can generate various powers and supply the generated powers to the control driver 400, the gate driver 200, the data driver 300, and the light emitting display panel 100.

The data driver 300 can supply data voltages Vdata to the data lines DL1 to DLd.

To this end, the data driver 300, as illustrated in FIG. 4, can include a shift register 310 which outputs a sampling signal, a latch 320 which latches data signal Data received from the control driver 400, a digital-to-analog converter 330 which converts the data signal Data, transmitted from the latch 320, into a data voltage Vdata and outputs the data voltage Vdata, and an output buffer 340 which outputs the data voltage, transmitted from the digital-to-analog converter 330, to the data line DL based on a source output enable signal SOE.

The shift register 310 can output the sampling signal by using the data control signal DCS received from the control signal generator 420. For example, the data control signals DCS transmitted to the shift register 310 can include a source start pulse SSP and a source shift clock signal SSC.

The latch 320 can latch data signals Data sequentially received from the control driver 400, and then output the data signals Data to the digital-to-analog converter 330 at the same time based on the sampling signal.

The digital-to-analog converter 330 can convert the data signals Data transmitted from the latch 320 into data voltages Vdata and output the data voltages Vdata.

The output buffer 340 can simultaneously output the data voltages Vdata transmitted from the digital-to-analog converter 330 to data lines DL1 to DLd of the light emitting display panel 100 based on the source output enable signal SOE transmitted from the control signal generator 420.

To this end, the output buffer 340 can include a buffer 341 which stores the data voltage Vdata transmitted from the digital-to-analog converter 330 and a switch 342 which outputs the data voltage Vdata stored in the buffer 341 to the data line DL based on the source output enable signal SOE.

For example, when the switches 342 are turned on based on the source output enable signal SOE simultaneously supplied to the switches 342, the data voltages Vdata stored in the buffers 341 can be supplied to the data lines DL1 to DLd through the switches 342.

The data voltages Vdata supplied to the data lines DL1 to DLd can be supplied to pixels P connected to a gate line GL supplied with a gate pulse GP.

Finally, the gate driver 200 can be directly embedded into the non-display area NDA by using a gate-in panel (GIP) type, or the gate driver 200 can be provided in the display area DA in which light emitting devices ED are provided, or the gate driver 200 can be provided on a chip on film mounted in the non-display area NDA.

The gate driver 200 can supply gate pulses GP1 to GPg to the gate lines GL1 to GLg.

When a gate pulse GP generated by the gate driver 200 is supplied to a gate of the switching transistor Tsw1 included in the pixel P, the switching transistor Tsw1 can be turned on. When the switching transistor Tsw1 is turned on, data voltage Vdata supplied through a data line DL can be supplied to the pixel P.

When a gate-off signal generated by the gate driver 200 is supplied to the switching transistor Tsw1, the switching transistor Tsw1 can be turned off. When the switching transistor Tsw1 is turned off, a data voltage cannot be supplied to the pixel P any longer.

The gate signal GS supplied to the gate line GL can include the gate pulse GP and the gate-off signal.

To supply gate pulses GP1 to GPg to gate lines GL1 to GLg, the gate driver 200, as illustrated in FIG. 5, can include stages ST1 to STg connected to gate lines GL1 to GLg.

Each of the stages ST1 to STg can be connected to one gate line GL, but can be connected to at least two gate lines GL.

To generate gate pulses GP1 to GPg, a start signal VST and at least one gate clock GCLK which are generated by the control signal generator 420 can be transferred to the gate driver 200. For example, the start signal VST and the at least one gate clock GCLK can be included in the gate control signal GCS.

One of the stages ST1 to STg can be driven by a start signal VST to output a gate pulse GP to a gate line GL. The gate pulse GP can be generated by a gate clock GCLK.

At least one of signals output from a stage ST where a gate pulse is output can be supplied to another stage ST to drive another stage ST. Accordingly, a gate pulse can be output in another stage ST.

For example, the stages ST can be driven sequentially to sequentially supply the gate pulses GP to the gate lines GL.

In this case, when the sensing control signal SCS and the gate signal GS illustrated in FIG. 2 are different, the gate driver 200 can further include other stages for generating sensing control signals SCS in addition to the stages ST1 to STg illustrated in FIG. 5.

For example, the light emitting display panel 100 can be provided with sensing control lines SCL in parallel with the gate lines GL1 to GLg, and the gate driver 200 can be provided with stages connected to the sensing control lines SCL.

The stages connected to the sensing control lines SCL can be sequentially driven to sequentially output sensing pulses to the sensing control lines SCL.

The structure and function of stages sequentially outputting sensing pulses can be the same as or similar to the structure and function of stages sequentially outputting gate pulses described with reference to FIG. 2.

In addition, when the pixel P is further provided with another transistor in addition to the switching transistor Tsw1 and the sensing transistor Tsw2, and another transistor is turned on or off by a signal transmitted from the gate driver 200, the gate driver 200 can further include a stage connected to another transistor.

Hereinafter, for convenience of description, a gate signal GS for turning on or off the switching transistor Tsw1, a sensing control signal SCS for turning on or off the sensing transistor Tsw2, and a signal for turning on or off another transistor are collectively referred to as a scan signal.

For example, a signal supplied from the gate driver 200 to the pixel P to turn on or off the transistor provided in the pixel P can be a scan signal.

Furthermore, in the following description, a signal supplied from the gate driver 200 to the pixel P to turn on the transistor provided in the pixel P is referred to as a scan pulse, and a signal supplied from the gate driver 200 to the pixel P to turn off the transistor provided in the pixel P is referred to as a scan-off signal.

Accordingly, the gate pulse GP and the sensing pulse can be scan pulses, and the gate-off signal and the sensing-off signal can be scan-off signals.

In this case, the scan signal can include the scan pulse and the scan-off signal.

Also, a line to which a scan signal is supplied is referred to as a scan line. Accordingly, each of the gate line GL and the sensing control line SCL can be a scan line.

As described above, the structure and function of the stage generating the gate signal GS can be the same as or similar to the structure and function of the stage generating the sensing control signal SCS. In addition, the structure and function of the stage that generates a scan signal to be supplied to another transistor provided in the pixel P can also be the same as or similar to the structure and function of the stage that generates a gate signal GS or a sensing control signal SCS.

Therefore, the stage described below can be a stage that generates a gate signal GS, a stage that generates a sensing control signal SCS, or a stage that generates another scan signal.

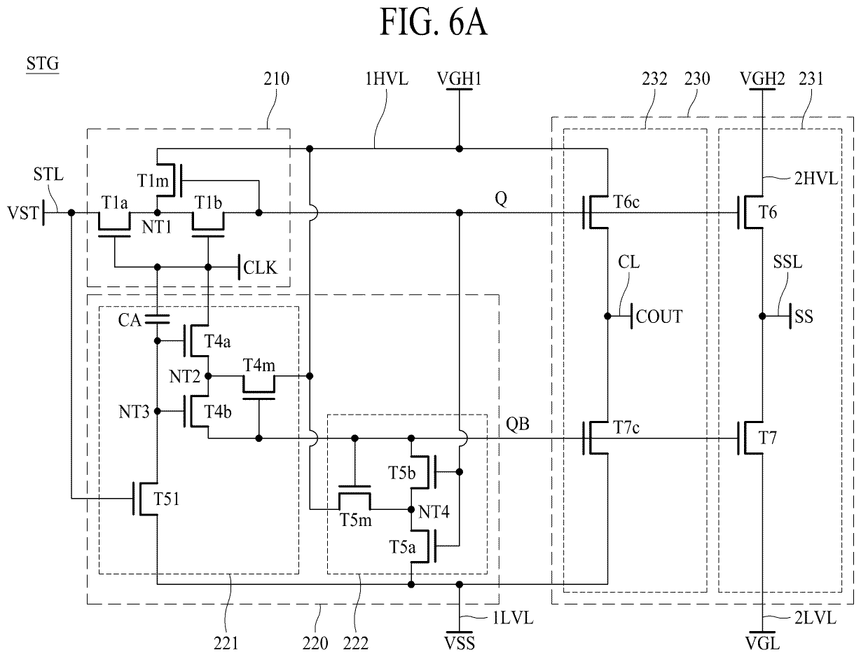

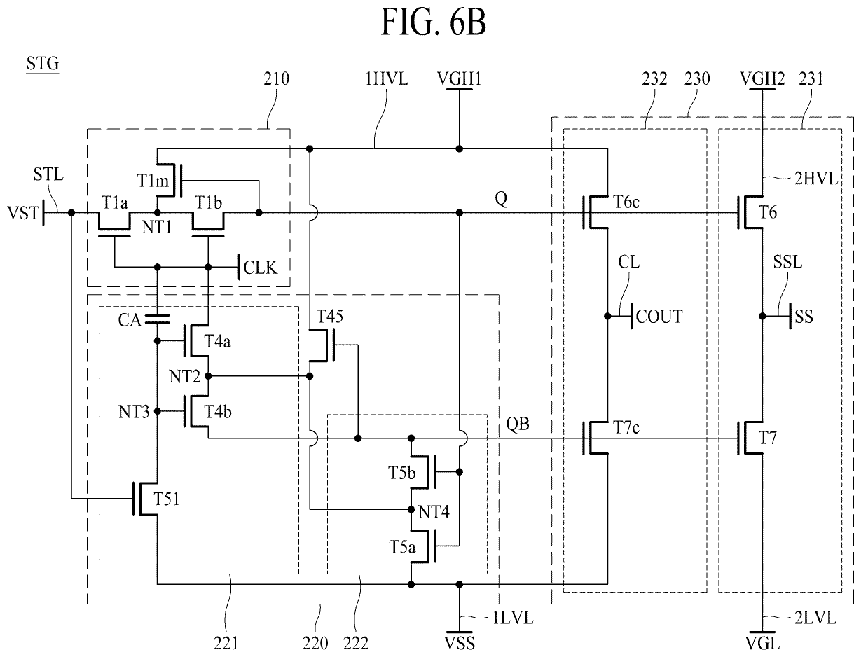

FIGS. 6A and 6B are example diagrams illustrating a structure of a stage applied to a light emitting display apparatus according to an example embodiment of the present disclosure. In the following descriptions, details that are the same as or similar to those described with reference to FIGS. 1 to 5 are omitted or briefly described.

In this case, the stage STG illustrated in FIG. 6A can be any one of various types of stages provided in the gate driver 200.

For example, the stage STG illustrated in FIG. 6A can be a stage that generates a gate signal GS, a stage that generates a sensing control signal SCS, or a stage STG that generates a scan signal SS to be transmitted to another transistor provided in the pixel P. Therefore, in the following description, a reference numeral STG can be given to the stage to distinguish the stage ST illustrated in FIG. 5 that generates the gate signal GS.

A light emitting display apparatus according to an example embodiment of the present disclosure can include a light emitting display panel 100 including pixels P and stages STG for supplying scan signals SS to the pixels P.

In this case, each of the stages STG can start to be driven by a start pulse, and can output a scan pulse having the same pulse width as the start pulse.

The start signal VST can include a start pulse and a start-off signal. When the start pulse is supplied to the gates of a 6c-th transistor T6c and a 6th transistor T6, the 6c-th transistor T6c and the 6th transistor T6 can be turned on. Also, the 6c-th transistor T6c and the 6th transistor T6 can be turned off by a start-off signal.

The scan signal SS can include a scan pulse and a scan-off signal. When the scan pulse is supplied to the gate of the transistor provided in the pixel, the transistor can be turned on, and when the scan-off signal is supplied to the gate of the transistor provided in the pixel, the transistor can be turned off.

According to the light emitting display apparatus according to an example embodiment of the present disclosure, a pulse width of a scan pulse can be the same as a pulse width of a start pulse. Accordingly, when the pulse width of the start pulse supplied to the stage STG is changed, scan pulses having different pulse widths can be output from the stages STG having the same structure.

A start signal supplied to a stage (hereinafter, simply referred to as a first stage) that outputs a scan pulse first among the stages STG can be generated by the control driver 400. A start signal supplied to the remaining stages STGs except for the first stage can be supplied from a front stage.

Here, the front stage can mean a stage that output a start pulse before the current stage that is outputting a start pulse. The current stage can be a rear stage with respect to the front stage.

For example, a front stage of a second stage can be the first stage, and a front stage of a third stage can be the second stage. In addition, a rear stage of the first stage can be the second stage, and a rear stage of the second stage can be the third stage. However, the present disclosure is not limited thereto. Accordingly, at least one other stage can be provided between the current stage and the front stage.

In addition, a start pulse output from the front stage and supplied to the rear stage can be the same signal as a scan pulse output from the front stage, or can be a signal output simultaneously with the scan pulse with the same magnitude and phase as the scan pulse output from the front stage.

A signal output from the front stage and transmitted to the current stage is referred to as a carry signal COUT. Accordingly, the carry signal COUT output from the front stage can be a start signal VST of the current stage.

Each of the stages STG can include a start unit 210, which is driven by a start signal VST including a start pulse and generates a Q node voltage, an inverting unit 220, which generates a QB node voltage opposite to the Q node voltage by using the start signal VST, and a signal generation unit 230, which generates a scan signal SS and a carry signal COUT by using the Q node voltage and the QB node voltage, as illustrated in FIG. 6A.

First, the start unit 210 can include a 1a-th transistor, which includes a first terminal to which a start signal VST is supplied, a second terminal connected to a first node NT1, and a gate to which a clock CLK is supplied, a 1b-th transistor, which includes a first terminal connected to the first node NT1, a second terminal connected to the signal generation unit 230 through a Q node Q, and a gate through which a clock CLK is supplied, and a 1m-th transistor T1m, which includes a first terminal connected to the first node NT1, a gate connected to the Q node Q, and a second terminal connected to a first high voltage line 1HVL to which a first high voltage VGH1 is supplied.

In this case, the gate of the 1a-th transistor T1a and the gate of the 1b-th transistor T1b can be connected to the inverting unit 220.

Next, the inverting unit 220 can include a discharge control unit 222, which is connected to a Q node Q to which a Q node voltage is supplied and a QB node QB to which a QB node voltage is supplied, and discharge a QB node voltage charged in the QB node QB, and a charging control unit 221, which charge the QB node voltage in the QB node QB.

The charging control unit 221 can include a 4a-th transistor T4a, which includes a first terminal supplied with a clock CLK supplied to the start unit 210, a second terminal connected to a second node NT2, and a gate connected to a third node NT3, a 4b-th transistor T4b, which includes a first terminal connected to the second node NT2, a second terminal connected to the QB node, and a gate connected to the third node NT3, a 4m-th transistor T4m, which includes a first terminal connected to the second node NT2, a gate connected to the QB node QB, and a second terminal connected to the first high voltage line 1HVL to which the first high voltage VGH1 is supplied, a 51-th transistor T51, which includes a first terminal connected to the third node NT3, a second terminal connected to a first low voltage line 1LVL to which a first low voltage VSS is supplied, and a gate connected to a start signal line STL supplied with a start signal VST, and a first capacitor CA, which includes a first terminal to which the clock CLK is supplied and a second terminal connected to the third node NT3.

The charging control unit 221 can transmit a high level of the clock CLK to the QB node QB, and accordingly, a high level QB node voltage can be charged in the QB node QB.

The discharge control unit 222 can include a 5b-th transistor T5b, a 5a-th transistor T5a, and a 5m-th transistor T5m. The 5b-th transistor can include a first terminal connected to the QB node QB, a second terminal connected to a fourth node NT4, and a gate connected to the Q node Q. The 5a-th transistor can include a first terminal connected to the fourth node NT4, a second terminal connected to the first low voltage line 1LVL to which the first low voltage VSS is supplied, and a gate connected to the Q node Q. The 5m-th transistor can include a first terminal connected to the first high voltage line 1HVL to which the first high voltage VGH1 is supplied, a second terminal connected to the fourth node NT4, and a gate connected to the QB node QB.

When the Q node Q is changed to a high level, the discharge control unit 222 can supply the low-level first low voltage VSS to the QB node QB, and accordingly, the high-level QB node voltage charged in the QB node QB can be discharged.

Next, the signal generation unit 230 can include a scan signal unit 231 and a carry signal unit 232. The scan signal unit 231 can be connected to the Q node Q to which the Q node voltage is supplied, can be connected to the QB node QB to which QB node voltage is supplied, and output a scan signal SS to the scan line SSL. The carry signal unit 232 can output a carry signal COUT used as a start signal VST at a rear stage.

The scan signal unit 231 can include a 6th transistor T6 and 7th transistor T7. The 6th transistor can include a first terminal connected to a second high voltage line 2HVL to which a second high voltage VGH2 is supplied, a second terminal connected to the scan line SSL, and a gate connected to the Q node Q. The 7th transistor can include a first terminal connected to the scan line SSL, a second terminal connected to the second low voltage line 2LVL to which the second low voltage VGL is supplied, and a gate connected to the QB node QB.

The carry signal unit 232 can include a 6c-th transistor T6c and a 7c-th transistor T7c. The 6c-th transistor can include a first terminal connected to the first high voltage line 1HVL to which the first high voltage VGH1 is supplied, a second terminal connected to a carry line CL, and a gate connected to the Q node Q. The 7c-th transistor T7c can include a first terminal connected to the carry line CL, a second terminal connected to the first low voltage line 1LVL to which the first low voltage VSS is supplied, and a gate connected to the QB node QB.

Finally, the 4m-th transistor T4m and the 5m-th transistor T5m illustrated in FIG. 6A can be integrated into a 45-th transistor T45, as illustrated in FIG. 6B.

For example, in FIG. 6A, the gate of the 4m-th transistor T4m and the gate of the 5m-th transistor T5m are commonly connected to the QB node QB, the 4m-th transistor T4m performs a function of supplying the high-level first high voltage VGH1 to the second node NT2, and the 5m-th transistor T5m performs a function of supplying the high-level first high voltage VGH1 to the fourth node NT4.

That is, the 4m-th transistor T4m and the 5m-th transistor T5m can be simultaneously turned on to supply the high-level first high voltage VGH1 to the second node NT2 and the fourth node NT4.

Accordingly, the 4m-th transistor T4m and the 5m-th transistor T5m illustrated in FIG. 6A can be integrated into the 45-th transistor T45 illustrated in FIG. 6B.

For example, a gate of the 45-th transistor T45 illustrated in FIG. 6B is also connected to the QB node QB. Accordingly, when the high-level QB node voltage is supplied to the QB node QB, the 45-th transistor T45 can be turned on. When the 45-th transistor T45 is turned on, the high-level first high voltage VGH1 can be supplied to the second node NT2 and the fourth node NT4 through the 45-th transistor T45.

In this case, the 45-th transistor T45 can be included in the charging control unit 221 or the discharging control unit 222.

Hereinafter, for convenience of description, a light emitting display apparatus according to the present disclosure will be described using the stage STG illustrated in FIG. 6A.

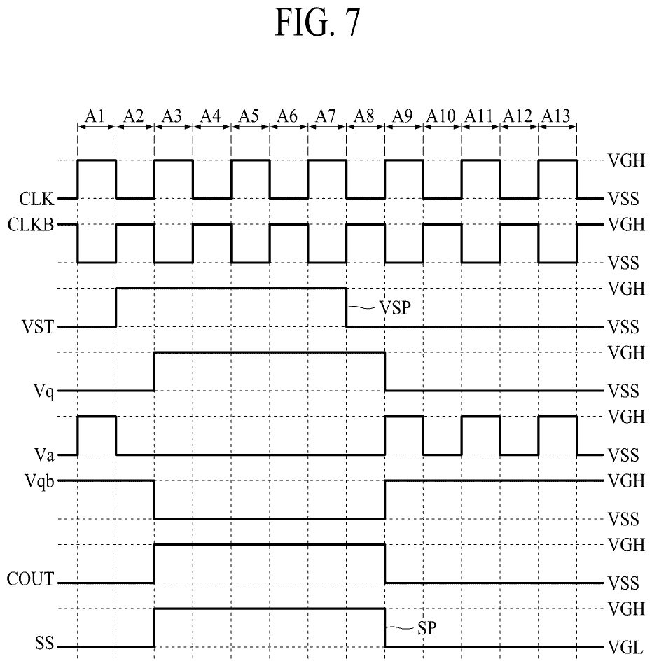

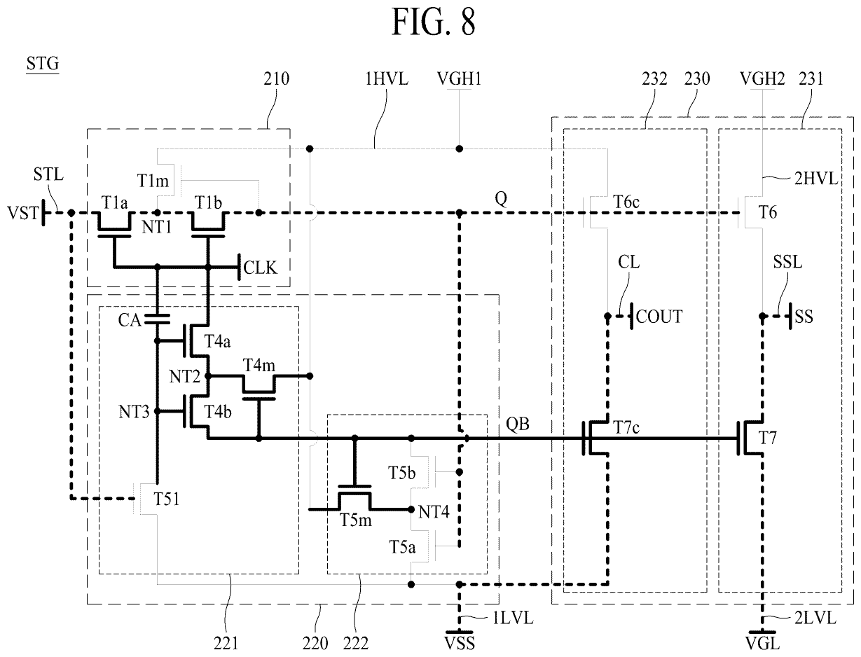

FIG. 7 is an example diagram illustrating signals supplied to a stage applied to a light emitting display apparatus according to an example embodiment of the present disclosure and signals generated from the stage, and FIGS. 8 to 13 are example diagrams for explaining a method of operating the stage illustrated in FIG. 6A. A clock indicated by the reference numeral CLKB in FIG. 7 can be a clock CLK input to a front stage or a rear stage of the stage illustrated in FIG. 6A. In addition, lines indicated by dark solid lines in FIGS. 8 to 13 can mean lines to which high-level signals are supplied, and lines indicated by dotted lines can mean lines to which low-level signals are supplied. In the following description, a high level can mean a voltage capable of turning on the transistor, and a low level can mean a voltage capable of turning off the transistor.

For example, a high level of the signals illustrated in FIG. 7 can be one of the first high voltage VGH1 and the second high voltage VGH2 illustrated in FIG. 6A, and a low level of the signals illustrated in FIG. 7 can be one of the first low voltage VSS and the second low voltage VGL illustrated in FIG. 6A. For convenience of description, the high level is indicated by the reference numeral VGH and the low level is indicated by the reference numeral VSS or VGL in FIG. 7.

First, as shown in FIGS. 7 and 8, in a first period A1, a high-level clock CLK and a low-level start signal VST can be supplied to the stage STG. Accordingly, the Q node voltage Vq can become a low level, a voltage applied to the third node (hereinafter, simply referred to as a third node voltage Va) can become a high level, a QB node voltage Vqb can become a high level, a carry signal COUT can become a low level, and a scan signal SS can become a low level.

Accordingly, the 6c-th transistor T6c, the 6th transistor T6, the 51-th transistor T51, the 5a-th transistor T5a, and the 5b-th transistor T5b can be turned off, and the 1a-th transistor T1a, the 1b-th transistor T1b, the 4a-th transistor T4a, the 4b-th transistor T4b, the 4m-th transistor T4m, the 5m-th transistor T5m, the 7c-th transistor T7c, and the 7th transistor T7 can be turned on.

For example, a high-level signal can be supplied to the third node NT3 by the low-level start signal VST and the high-level clock CLK, and accordingly, the 4a-th transistor T4a, the 4b-th transistor T4b, and the 4m-th transistor T4m can be turned on.

In addition, the QB node QB can become a high level by the high-level clock CLK supplied through the 4a-th transistor T4a and the 4b-th transistor T4b, and the 5m-th transistor T5m whose gate is connected to the QB node QB can be turned on.

In this case, because the 5m-th transistor T5m is turned on and thus a high-level signal is supplied to the fourth node NT4, the gate-source voltage Vgs of the 5b-th transistor T5b can be much less than 0 (Vgs<<0). Accordingly, the 5b-th transistor T5b can be completely turned off, and thus current leakage in the QB node QB can be prevented or suppressed. Accordingly, the high level of the QB node QB can be stably maintained.

In addition, the 1a-th transistor T1a and the 1b-th transistor T1b can be turned on by the high-level clock CLK, and accordingly, the low-level start signal VST can be supplied to the Q node Q through the 1a-th transistor T1a and the 1b-th transistor T1b. Accordingly, the 6c-th transistor T6c and the 6th transistor T6 can be turned off.

However, the 7c-th transistor T7c and the 7th transistor T7 connected to the QB node QB can be turned on by the high-level clock CLK applied to the QB node QB through the 4a-th transistor T4a and the 4b-th transistor T4b. Accordingly, the low-level first low voltage VSS transmitted through the 7c-th transistor T7c can be output through the carry line CL, and the low-level second low voltage VGL transmitted through the 7th transistor T7 can be output through the scan line SSL. The signal output through the carry line CL is a carry signal COUT, and the signal output through the scan line SSL is a scan signal SS.

That is, the low-level carry signal COUT and the low-level scan signal SS can be outputted in the first period A1.

The carry signal COUT can be a start signal VST of a rear stage, and the scan signal SS can be supplied to a gate of the transistor provided in the pixel P through the scan line SSL.

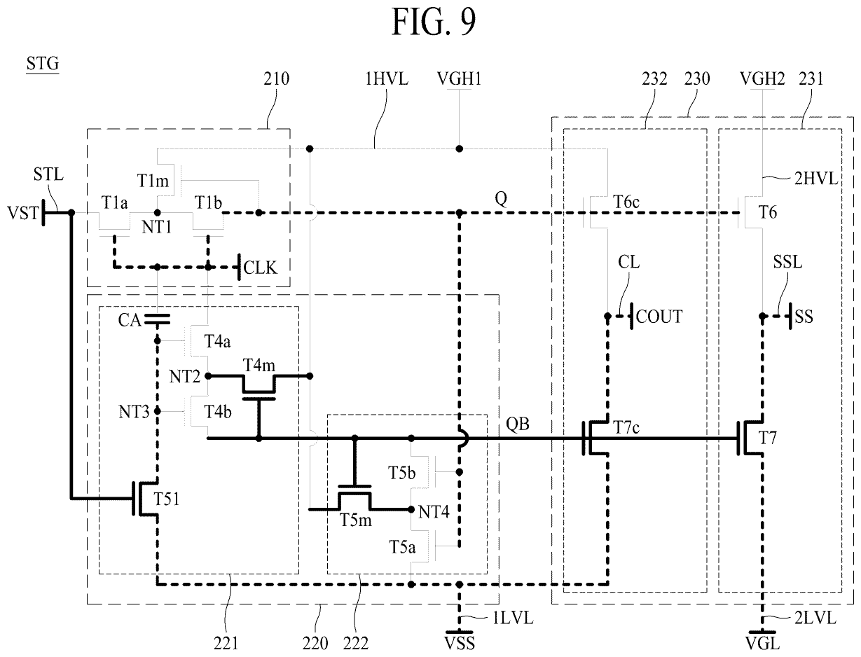

Second, as shown in FIGS. 7 and 9, in a second period A2, a low-level clock CLK and a high-level start signal VST, that is, a start pulse VSP, can be supplied to the stage STG. Accordingly, the Q node voltage Vq can become a low level, the third node voltage Va can become a low level, the QB node voltage Vqb can become a high level, the carry signal COUT can become a low level, and the scan signal SS can become a low level.

Accordingly, the 1a-th transistor T1a, the 1b-th transistor T1b, the 6c-th transistor T6c, the 6th transistor T6, the 4a-th transistor T4a, the 4b-th transistor T4b, the 5a-th transistor T5a, and the 5b-th transistor T5b can be turned off, and the 51-th transistor T51, the 4m-th transistor T4m, the 5m-th transistor T5m, the 7c-th transistor T7c, and the 7th transistor T7 can be turned on.

For example, the 51-th transistor T51 can be turned on by the high-level start signal VST, and accordingly, the first low voltage VSS can be supplied to the third node NT3 through the 51-th transistor T51. Accordingly, the 4a-th transistor T4a and the 4b-th transistor T4b connected to the third node NT3 can be turned off. In this case, the QB node QB can be maintained at a high level. That is, the QB node QB, which was at a high level in the first period A1, can be maintained at a high level in the second period A2.

Accordingly, the 4m-th transistor T4m and the 5m-th transistor T5m can be turned on, and a high-level signal can be supplied to the second node NT2 and the fourth node NT4. Accordingly, the gate-source voltage Vgs of the 4b-th transistor T4b and the 5b-th transistor T5b can be much less than 0 (Vgs<<0). Accordingly, the 4b-th transistor T4b and the 5b-th transistor T5b can be completely turned off, and thus current leakage at the QB node QB can be prevented or suppressed. Accordingly, the QB node QB can be maintained at the high level.

In addition, the Q node Q, which has been supplied with the low-level signal during the first period A1, can still be maintained at the low-level because the 1a-th transistor T1a and the 1b-th transistor T1b are turned off. Accordingly, the low level can be supplied to the gates of the 6c-th transistor T6c and the 6th transistor T6. Accordingly, the 6c-th transistor T6c and the 6th transistor T6 can be turned off.

However, the 7c-th transistors T7c and the 7th transistor T7 connected to the high-level QB node QB can be turned on. Accordingly, the low-level first low voltage VSS transmitted through the 7c-th transistor T7c can be output through the carry line CL, and the low-level second low voltage VGL transmitted through the 7th transistor T7 can be output through the scan line SSL.

Accordingly, in the first period A1 and the second period A2, the low-level first low voltage VSS can be output through the carry line CL, and the low-level second low voltage VGL can be output through the scan line SSL.

That is, in the first period A1 and the second period A2, the low-level carry signal COUT and the low-level scan signal can be output.

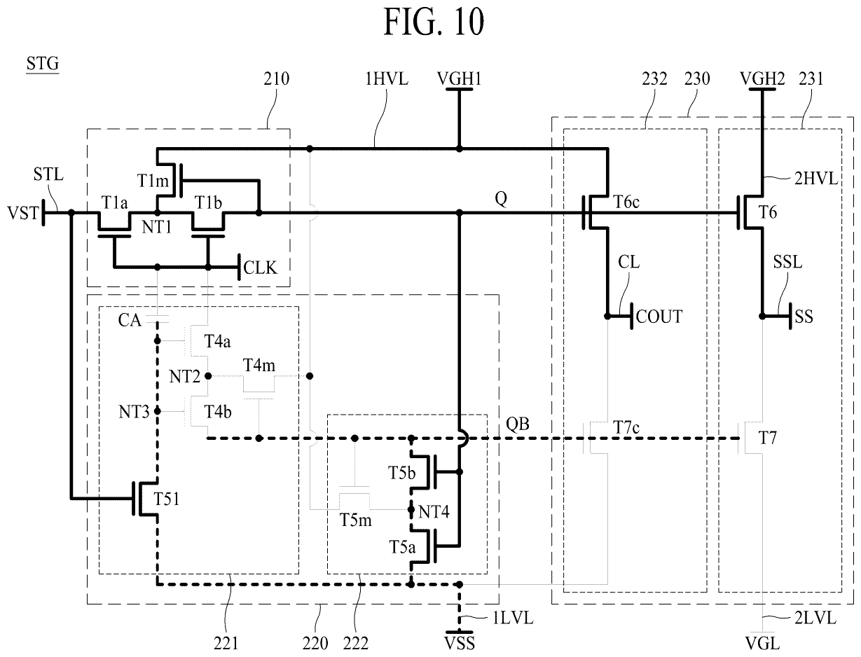

Third, as shown in FIGS. 7 and 10, a high-level clock CLK and a high-level start signal VST can be supplied to the stage STG in a third period A3. Accordingly, the Q node voltage Vq can become a high level, the third node voltage Va can become a low level, the QB node voltage Vqb can become a low level, the carry signal COUT can become a high level, and the scan signal SS can become a high level.

Accordingly, the 1a-th transistor T1a, the 1b-th transistor T1b, the 6c-th transistor T6c, the 6th transistor T6, the 51-th transistor T51, the 5a-th transistor T5a, and the 5b-th transistor T5b can be turned on, and the 4a-th transistor T4a, the 4b-th transistor T4b, the 4m-th transistor T4m, the 5m-th transistor T5m, the 7c-th transistor T7c, and the 7th transistor T7 can be turned off.

For example, the 1a-th transistor T1a and the 1b-th transistor T1b can be turned on by the high-level clock CLK, and the high-level start signal VST can be transmitted to the Q node Q through the turned-on 1a-th transistor T1a and 1b-th transistor T1b. The 6c-th transistor T6c and the 6th transistor T6 can be turned on by the high-level Q node Q.

Accordingly, the high-level first high voltage VGH1 transmitted through the 6c-th transistor T6c can be output through the carry line CL, and the high-level second high voltage VGH2 transmitted through the 6th transistor T6 can be output through the scan line SSL. The signal output through the carry line CL is the carry signal COUT, and the signal output through the scan line SSL is the scan signal SS.

That is, in the third period A3, the high-level carry signal COUT and the high-level scan signal SS can be output.

In this case, the 51-th transistor T51 can be turned on by the high-level start signal VST, and the first low voltage VSS can be supplied to the third node NT3 through the 51-th transistor T51.

Accordingly, the 4a-th transistor T4a and the 4b-th transistor T4b can be turned off.

In this case, the 5b-th transistor T5b and the 5a-th transistor T5a of which the gates are connected to the high-level Q node Q can be turned on. Accordingly, the first low voltage VSS can be supplied to the QB node QB through the 5b-th transistor T5b and the 5a-th transistor T5a, and thus the QB node QB can become a low level. In addition, the high-level QB node voltage can be discharged.

Accordingly, the 7c-th transistor T7c and the 7th transistor T7 can be turned off. Accordingly, the first low voltage VSS can no longer be output to the carry line CL through the 7c-th transistor T7c, and the second low voltage VGL can no longer be output to the scan line SSL through the 7th transistor T7.

Accordingly, in the third period A3, the high-level carry signal COUT can be output through the 6c-th transistor T6c and the carry line CL, and the high-level scan signal SS can be output through the 6th transistor T6 and the scan line SSL.

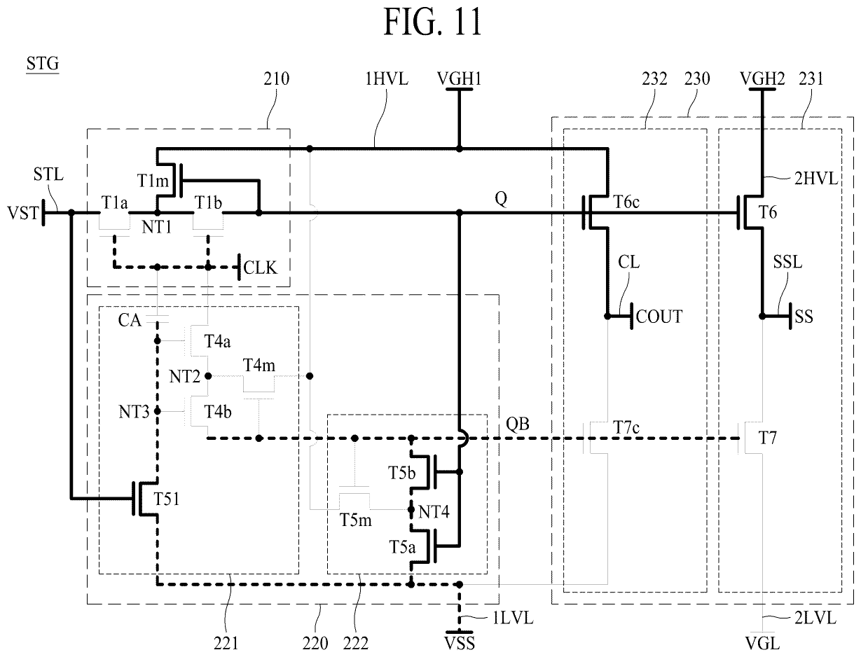

Fourth, as shown in FIGS. 7 and 11, in a fourth period A4, a low-level clock CLK and a high-level start signal VST can be supplied to the stage STG. Accordingly, the Q node voltage Vq can become a high level, the third node voltage Va can become a low level, the QB node voltage Vqb can become a low level, the carry signal COUT can become a high level, and the scan signal SS can become a high level.

Accordingly, the 1m-th transistor T1m, the 6c-th c transistor T6c, the 6th transistor T6, the 51-th transistor T51, the 5a-th transistor T5a, and the 5b-th transistor T5b can be turned on, and the 1a-th transistor T1a, the 1b-th transistor T1b, the 4a-th transistor T4a, the 4b-th transistor T4b, the 4m-th transistor T4m, the 5m-th transistor T5m, the 7c-th transistor T7c, and the 7th transistor T7 can be turned off.

For example, even if the 1a-th transistor T1a and the 1b-th transistor T1b are turned off by the low-level clock CLK, the Q node Q can maintain a high level, and accordingly, the 6c-th transistor T6c and the 6th transistor T6 can be continuously turned on.

In this case, the 1m-th transistor T1m can be maintained in a turned-on state by the high-level Q node Q, and thus the first node NT1 can be maintained in a high-level state. Accordingly, the gate-source voltage Vgs of the 1b-th transistor T1b can be much less than 0 (Vgs<<0). Accordingly, the 1b-th transistor T1b can be completely turned off, and thus current leakage at the Q node Q can be prevented or suppressed. Accordingly, the Q node Q can be stably maintained at the high level.

Accordingly, the high-level first high voltage VGH1 transmitted through the 6c-th transistor T6c can be output through the carry line CL, and the high-level second high voltage VGH2 transmitted through the 6th transistor T6 can be output through the scan line SSL.

That is, in the third period A3 and the fourth period A4, the high-level carry signal COUT and the high-level scan signal SS can be output.

In this case, the 51-th transistor T51 can be turned on by the high-level start signal VST, and the first low voltage VSS can be supplied to the third node NT3 through the 51-th transistor T51.

Accordingly, the 4a-th transistor T4a and the 4b-th transistor T4b can be turned off.

In this case, the 5b-th transistor T5b and the 5a-th transistor T5a, whose gates are connected to the high-level Q node Q, can be turned on. Accordingly, the first low voltage VSS can be supplied to the QB node QB through the 5b-th transistor T5b and the 5a-th transistor T5a, and thus the QB node QB can become a low level.

Accordingly, the 7c-th transistor T7c and the 7th transistor T7 can be turned off. That is, in the fourth period A4, as in the third period A3, the 7c-th transistor T7c and the 7th transistor T7 can be turned off.

Accordingly, the first low voltage VSS cannot be output to the carry line CL through the 7c-th transistor T7c, and the second low voltage VGL cannot be output to the scan line SSL through the 7th transistor T7.

Accordingly, in the third period A3 and the fourth period A4, the high-level carry signal COUT can be output through the 6c-th transistor T6c and the carry line CL, and the high-level scan signal SS can be output through the 6th transistor T6 and the scan line SSL.

Fifth, in the fifth to seventh periods A5 to A7, the operations of the third and fourth periods A3 and A4 can be repeated.

For example, as illustrated in FIG. 7, in the fifth period A5, the same signals as the third period A3 can be input to the stage STG, and accordingly, the same signals as the third period A3 can be generated.

In addition, in the sixth period A6, the same signals as the fourth period A4 can be input to the stage STG, and accordingly, the same signals as the fourth period A4 can be generated.

Also, in the seventh period A7, the same signals as the third period A3 can be input to the stage STG, and accordingly, the same signals as the third period A3 can be generated.

Accordingly, in the fifth to seventh periods A5 to A7, the high-level carry signal COUT can be output through the 6c-th transistor T6c and the carry line CL, and the high-level scan signal SS can be output through the 6th transistor T6 and the scan line SSL.

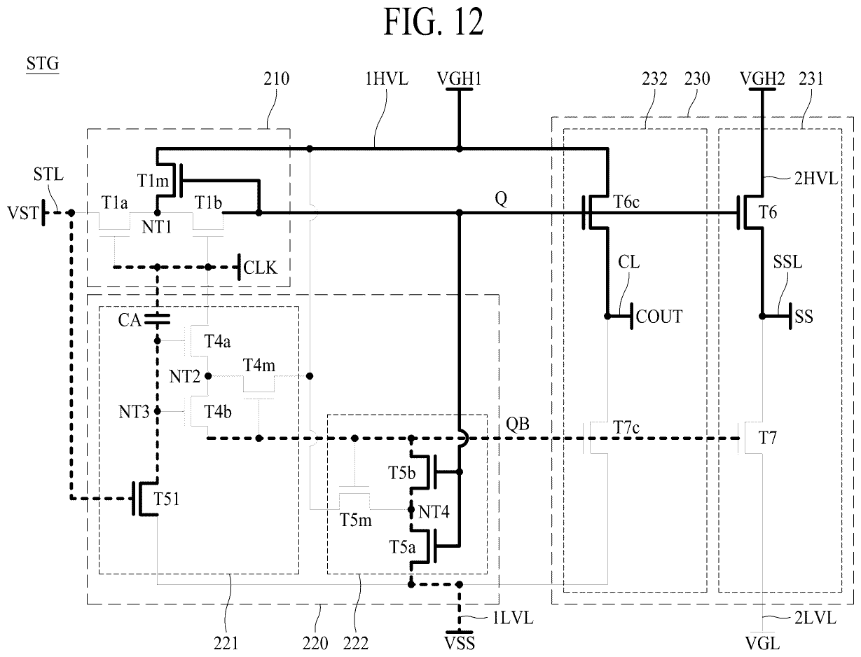

Sixth, as shown in FIGS. 7 and 12, in an eighth period A8, a low-level clock CLK and a low-level start signal VST can be supplied to the stage STG. Accordingly, the Q node voltage Vq can become a high level, the third node voltage Va can become a low level, the QB node voltage Vqb can become a low level, the carry signal COUT can become a high level, and the scan signal SS can become a high level.

Accordingly, the 1m-th transistor T1m, the 6c-th transistor T6c, the 6th transistor T6, the 5a-th transistor T5a, and the 5b-th transistor T5b can be turned on, and the 1a-th transistor T1a, the 1b-th transistor T1b, the 51-th transistor T51, the 4a-th transistor T4a, the 4b-th transistor T4b, the 4m-th transistor T4m, the 5m-th transistor T5m, the 7c-th transistor T7c, and the 7th transistor T7 can be turned off.

For example, even if the 1a-th transistor T1a and the 1b-th transistor T1b are turned off by the low-level clock CLK, the Q node Q can maintain a high level, and accordingly, the 6c-th transistor T6c and the 6th transistor T6 can be continuously turned on.

In this case, the 1m-th transistor T1m can be maintained in a turned-on state by the high-level Q node Q, and thus the first node NT1 can be maintained in a high-level state. Accordingly, the gate-source voltage Vgs of the 1b-th transistor T1b can be much less than 0 (Vgs<<0). Accordingly, the 1b-th transistor T1b can be completely turned off, and thus current leakage at the Q node Q can be prevented or suppressed.

Accordingly, the high-level first high voltage VGH1 transmitted through the 6c-th transistor T6c can be output through the carry line CL, and the high-level second high voltage VGH2 transmitted through the 6th transistor T6 can be output through the scan line SSL.

That is, in the third to eighth periods A3 to A8, a high-level carry signal COUT and a high-level scan signal SS can be output.

In this case, because the 51-th transistor T51 can be turned off by the low-level start signal VST and the third node NT3 can be maintained at the low level, the 4a-th transistor T4a and the 4b-th transistor T4b can be turned off.

The 5b-th transistor T5b and the 5a-th transistor T5a of which the gates are connected to the high-level Q node Q can be turned on. Accordingly, the first low voltage VSS can be supplied to the QB node QB through the 5b-th transistor T5b and the 5a-th transistor T5a, and thus the QB node QB can become a low level.

Accordingly, the 7c-th transistor T7c and the 7th transistor T7 can be turned off. That is, in the third to eighth periods A3 to A8, the 7c-th transistor T7c and the 7th transistor T7 can be turned off.

Accordingly, the first low voltage VSS cannot be output to the carry line CL through the 7c-th transistor T7c, and the second low voltage VGL cannot be output to the scan line SSL through the 7th transistor T7.

Accordingly, in the third to eighth periods A3 to A8, the high-level carry signal COUT can be output through the 6c-th transistor T6c and the carry line CL, and the high-level scan signal SS can be output through the 6th transistor T6 and the scan line SSL.

Seventh, in a ninth period A9, the operation of the first period A1 can be repeated.

For example, as illustrated in FIG. 7, in the ninth period A9, the same signals as the first period A1 can be input to the stage STG, and accordingly, the same signals as the first period A1 can be generated.

Accordingly, in the ninth period A9, the first low voltage VSS of the low level can be output through the carry line CL, and the second low voltage VGL of the low level can be output through the scan line SSL.

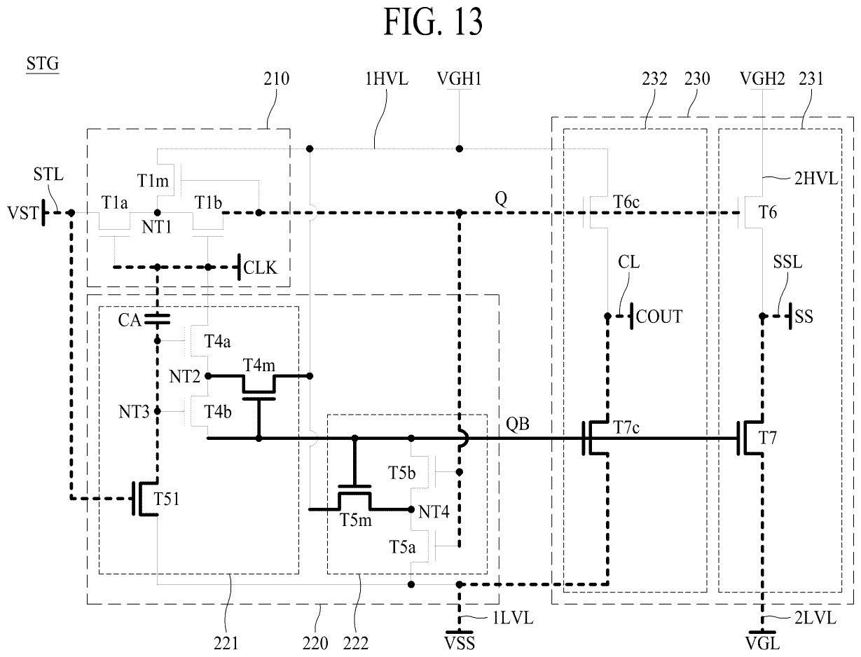

Eighth, as shown in FIGS. 7 and 13, in a tenth period A10, a low-level clock CLK and a low-level start signal VST can be supplied to the stage STG. Accordingly, the Q node voltage Vq can become a low level, the third node voltage Va can become a low level, the QB node voltage Vqb can become a high level, the carry signal COUT can become a low level, and the scan signal SS can become a low level.

Accordingly, the 1a-th transistor T1a, the 1b-th transistor T1b, the 1m-th transistor T1m, the 6c-th transistor T6c, the 6th transistor T6, the 4a-th transistor T4a, the 4b-th transistor T4b, the 5a-th transistor T5a, the 5b-th transistor T5b, and the 51-th transistor T51 can be turned off, and the 4m-th transistor T4m, the 5m-th transistor T5m, the 7c-th transistor T7c, and the 7th transistor T7 can be turned on.

For example, even if the 1a-th transistor T1a and the 1b-th transistor T1b are turned off by the low-level clock CLK, the Q node Q, which maintained the low level in the ninth period, can maintain the low level even in the tenth period A10, and accordingly, the 6c-th transistor T6c and the 6th transistor T6 can be continuously turned off.

Accordingly, the high-level first high voltage VGH1 cannot be output through the 6c-th transistor T6c and the carry line CL, and the high-level second high voltage VGH2 cannot be output through the 6th transistor T6 and the scan line SSL.

In this case, the 51-th transistor T51 can be turned off by the low-level start signal VST, the low level can be supplied to the first capacitor CA by the low-level clock CLK, and thus the third node NT3 can become the low level. Accordingly, the 4a-th transistor T4a and the 4b-th transistor T4b can be turned off.

In this case, the 5b-th transistor T5b and the 5a-th transistor T5a, whose gates are connected to the low-level Q node Q, can be turned off. Accordingly, the QB node QB, which maintained the high level in the ninth period A9, can be maintained at the high level in the tenth period A10.

Accordingly, the 4m-th transistor T4m and the 5m-th transistor T5m can be turned on, and a high-level signal can be supplied to the second node NT2 and the fourth node NT4. Accordingly, the gate-source voltage Vgs of the 4b-th transistor T4b and the 5b-th transistor T5b can be much less than 0 (Vgs<<0). Accordingly, the 4b-th transistor T4b and the 5b-th transistor T5b can be completely turned off, and thus current leakage at the QB node QB can be prevented or suppressed. Accordingly, the QB node QB can be maintained at a high level.

Accordingly, in the ninth period A9 and the tenth period A10, the low-level first low voltage VSS can be output through the carry line CL, and the low-level second low voltage VGL can be output through the scan line SSL.

That is, in the ninth period A9 and the tenth period A10, a low-level carry signal COUT and a low-level scan signal can be output.

Finally, the operations in the first and tenth periods A1 and A10 can be repeated from an eleventh period A11 until another high-level start signal VST is supplied.

For example, as illustrated in FIG. 7, in the eleventh period A11, the same signals as the first period A1 can be input to the stage STG, and accordingly, the same signals as the first period A1 can be generated.

Also, in a twelfth period A12, the same signals as the tenth period A10 can be input to the stage STG, and accordingly, the same signals as the tenth period A10 can be generated.

In addition, in a thirteenth period A13, the same signals as the first period A1 can be input to the stage STG, and accordingly, the same signals as the first period A1 can be generated.

Accordingly, from the eleventh period A11 until another high-level start signal VST is supplied, that is, from the eleventh period A11 until the second period A2 described above is resumed, the low-level carry signal COUT can be output through the 7c-th transistor T7c and the carry line CL, and the low-level scan signal SS can be output through the 7th transistor T7 and the scan line SSL.

By the methods described above, a high-level scan signal SS, that is, a scan pulse SP, can be output from the stage STG to the scan line SSL, and a high-level carry signal COUT can be output from the stage STG to the carry line CL.

In particular, according to the light emitting display apparatus according to an example embodiment of the present disclosure as described above, a scan pulse SP having the same pulse width as the pulse width of the start pulse VSP can be generated, as illustrated in FIG. 7.

The start pulse VSP can be generated by the control signal generator 420 of the control driver 400.

Accordingly, when the pulse width of the start pulse VSP generated by the control signal generator 420 is changed, the pulse width of the scan pulse SP can be simply changed.

In addition, when at least two scan signals SS have to be supplied to a pixel P and the pulse widths of the two scan signals SS have to be different, at least two scan pulses SP with different pulse widths can be generated using two stages STG having the same structure.

For example, if the pulse widths of the start pulses VSP supplied to the two stages STG are different, two scan pulses SP with different pulse widths can be generated.

Accordingly, according to the light emitting display apparatus according to an example embodiment of the present disclosure, even if the pulse width of the scan pulse SP is changed, the structure of the gate driver 200 need not be changed. Accordingly, the manufacturing cost and manufacturing period of the light emitting display apparatus can be reduced.

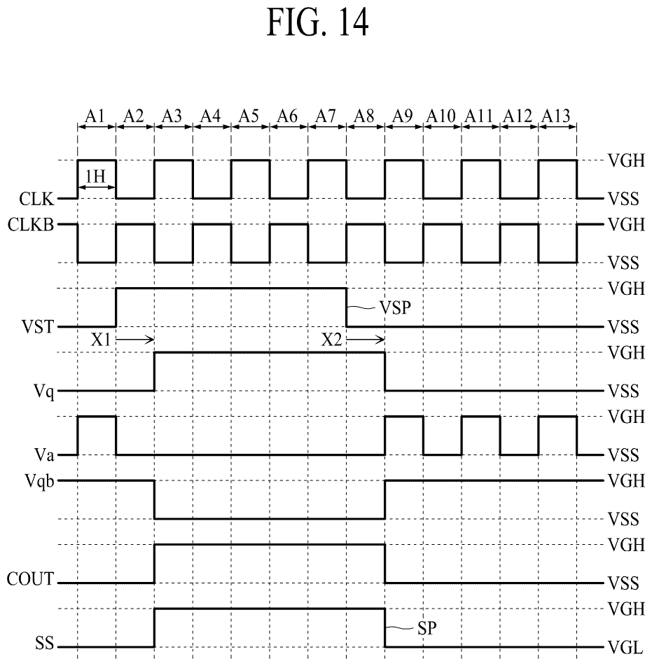

FIG. 14 is an example diagram for describing a function of a start unit applied to a light emitting display apparatus according to an example embodiment of the present disclosure. In this case, the timing diagram illustrated in FIG. 14 is the same as the timing diagram illustrated in FIG. 7, and particularly, a timing diagram for describing a function in which the Q node Q is maintained at a high level by the start unit 210. Therefore, in the following descriptions, details that is the same as or similar to those described with reference to FIGS. 6A to 13 are omitted or briefly described.

As described above with reference to FIG. 7, the clock CLK can be a clock supplied to the current stage STG illustrated in FIGS. 6A and 6B, and the clock CLKB can be a clock CLK input to a front stage or a rear stage of the current stage illustrated in FIGS. 6A and 6B.

In this case, CLK and CLKB can have an interval of 1 H. For example, as illustrated in FIG. 14, a high level of CLK and a high level of CLKB can have an interval of 1 H.

In this case, CLK and CLKB can have the same width, and each of the pulse widths of CLK and CLKB can be less than or equal to 1 H.

Hereinafter, for convenience of description, a light emitting display apparatus according to an example embodiment of the present disclosure will be described using an example in which the pulse width of the clock CLK is 1 H.

First, the start unit 210 can be driven by a start signal VST including a start pulse VSP and can generate a Q node voltage Vq. The Q node voltage Vq can be supplied to the Q node Q.

For example, the start unit 210 can receive a high-level start signal VST transmitted from the control driver 400 or a high-level carry signal COUT output from a front stage and supply a high-level Q node voltage Vq to the Q node Q after a predetermined time. The high-level carry signal COUT output from the front stage can be a start signal VST of a rear stage.

The start unit 210 can include a 1a-th transistor T1a, a 1b-th transistor T1b, and a 1m-th transistor T1m as described above.

Next, the 1a-th transistor T1a and the 1b-th transistor T1b can perform a function of delaying the start pulse VSP by the width of the clock CLK, for example, 1 H, and then supplying the start pulse VSP to the Q node Q.

The start pulse VSP supplied to the Q node Q can be a high-level Q node voltage Vq.

For example, the reference numeral X1 illustrated in FIG. 14 indicates that the Q node voltage Vq is changed to a high level after the start signal VST is changed to a high level and delayed by 1 H.

For example, after 1 H subsequent to the start signal VST changes from a low level to a high level, the clock CLK can become a high level, and when the clock CLK becomes a high level, the Q node voltage Vq of a high level can be supplied to the Q node Q.

In addition, the high-level start signal VST can be supplied to the stage STG in the second period A2, and the high-level Q node voltage Vq can be supplied to the Q node Q in the third period A3.

Next, while the start pulse VSP is supplied to the stage STG, the clock CLK can be alternately changed to a high level and a low level. That is, the clock CLK can be toggled.

In this case, the Q node Q can be maintained at a high level continuously. For example, the Q node voltage Vq can be maintained at a high level from the third period A3 to eighth period A8, and in the third to eighth periods A3 to A8, the clock CLK can be alternately changed to a high level and a low level.

A 1m-th transistor T1m can be provided to maintain the Q node Q at a high level in a fourth period A4, a sixth period A6, and an eighth period A8 in which the start pulse VSP is not supplied to the Q node Q. That is, the 1m-th transistor T1m can perform a function of maintaining the Q node Q at a previous state (e.g., a high level).

For example, when the clock CLK becomes low levels in the fourth period A4, the sixth period A6, and the eighth period A8, the 1a-th transistor T1a and the 1b-th transistor T1b are turned off. In this case, the gate-source voltage Vgs of the 1a-th transistor T1a and the 1b-th transistor T1b can be 0V.

However, when the threshold voltages of the 1a-th transistor T1a and the 1b-th transistor T1b become negative voltages, the gate-source voltage Vgs of the 1a-th transistor T1a and the 1b-th transistor T1b can be greater than 0, and in this case, the 1a-th transistor T1a and the 1b-th transistor T1b may not be turned off.

To prevent or suppress this, the 1m-th transistor T1m can be turned on when the Q node Q becomes the high level in the third period A3 to maintain the first node NT1 at the high level even in the fourth period A4.

Accordingly, the gate-source voltage Vgs of the 1b-th transistor T1b can be a value less than 0V, and accordingly, the 1b-th transistor T1b can be completely turned off in the fourth period T4.

Accordingly, the charge of the Q node Q cannot be leaked through the 1b-th transistor T1b, and accordingly, the Q node Q can be maintained at a high level in the third period A3 and the fourth period A4. By the principle described above, the Q node Q can be continuously maintained at a high level from the third period A3 to the eighth period A8.

In particular, as described above, in the third to eighth periods A3 to A8, the clock CLK can be alternately changed to the high level and the low level, and in the fifth and seventh periods A5 and A7, the high-level start signal VST can be supplied to the Q node Q by the high-level clock CLK.

Accordingly, the Q node Q can be maintained at a high level continuously in the third to eighth periods A3 to A8.

That is, the 1m-th transistor T1m can perform a memory function for maintaining the previous state.

Next, after 1 H subsequent to the start signal VST is changed from a high level to a low level, the clock CLK can be changed from a low level to a high level, and the Q node can be changed to a low level.

For example, a low-level start signal VST can be supplied to the stage STG in the eighth period A8, and the Q node voltage Vq can change from a high level to a low level in the ninth period A9 after 1 H.

Accordingly, the reference numeral X2 illustrated in FIG. 14 indicates that the Q node voltage Vq changes to the low level after the start signal VST is changed to the low level and delayed by 1 H.

From the tenth period A10 until the second period A2 starts again, the clock CLK can be alternately changed to a high level and a low level, and the low-level start signal VST can be supplied to the Q node Q by the high-level clock CLK.

Accordingly, from the tenth period A10 until the second period A2 starts again, the Q node Q can be maintained at a low level continuously.

Finally, the characteristics of the start unit 210 are summarized as follows.

As illustrated in FIG. 14, the clock CLK supplied to the start unit 210 can be changed from a high level to a low level when the start signal VST is changed from a low level to a high level, and the clock CLK can be changed from a high level to a low level when the start signal VST is changed from a high level to a low level.

The start unit 210 can supply the high-level start pulse VSP to the signal generation unit 230 when the clock CLK is changed from the low level to the high level after the start pulse VSP having the high level and the clock CLK having the low level are supplied.

For example, the high-level start pulse VSP can be the high-level Q node voltage Vq.

The start pulse VSP having a high level supplied to the start unit 210 and the Q node voltage Vq output from the start unit 210 and having a high level can have a phase difference equal to the pulse width of the clock CLK supplied to the start unit 210.

For example, as illustrated in FIG. 14, the start pulse VSP and the Q node voltage Vq can have a phase difference of 1 H, and in this case, the pulse width of the clock CLK can be 1 H.

However, as described above, the pulse widths of CLK and CLKB can be less than or equal to 1 H. In this case, the start pulse VSP having a high level supplied to the start unit 210 and the Q node voltage Vq having a high level output from the start unit 210 can have a phase difference greater than or equal to the pulse width of the clock CLK supplied to the start unit 210.

When the start signal VST having the high level is blocked by the start unit 210, the Q node voltage Vq can be continuously maintained at the high level.

For example, as described above, by the 1m-th transistor T1m and the toggle function of the clock CLK, the Q node voltage Vq can be continuously maintained at a high level from the third period A3 to the eighth period A8.

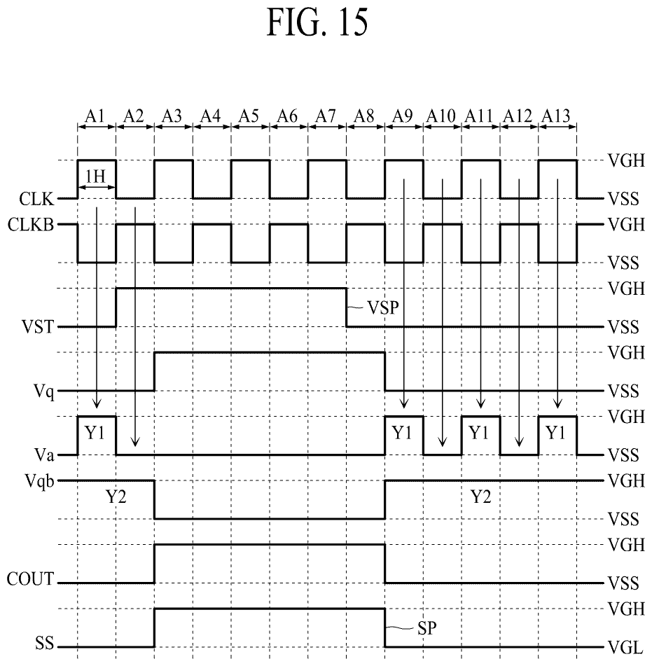

FIG. 15 is an example diagram for describing a function of an inverting unit applied to a light emitting display apparatus according to an example embodiment of the present disclosure. In this case, the timing diagram illustrated in FIG. 15 is the same as the timing diagram illustrated in FIG. 7, and particularly, a timing diagram for describing a function in which the QB node QB is maintained at a high level by the inverting unit 220. Therefore, in the following descriptions, details that are the same as or similar to those described with reference to FIGS. 6A to 14 are omitted or briefly described. In the following descriptions, the pulse width of the clock CLK is 1 H.

The inverting unit 220 can generate a QB node voltage Vqb opposite to the Q node voltage Vq by using the start signal VST.

For example, the inverting unit 220 can receive the start signal VST or the carry signal COUT output from the front stage and generate the QB node voltage Vqb having an inverted potential with the Q node voltage Vq by using the clock CLK and the Q node voltage Vq.

First, the first capacitor CA and the 51-th transistor T51 can be connected to a third node NT3 that is an auxiliary node of the QB node QB.

When the start signal VST is at a high level, the third node NT3 can be at a low level by the first low voltage VSS supplied through the 51-th transistor T51.

Also, when the start signal VST is at the low level, the clock CLK can be supplied to the third node NT3 through the first capacitor CA. Accordingly, the third node voltage Va can have the same shape as the clock CLK when the start signal VST is at the low level, as indicated by reference numeral Y1 in FIG. 15.

Next, when the third node voltage Va becomes a high level, the QB node voltage Vqb also becomes a high level, and then while the third node voltage Va toggles together with the clock CLK, the QB node voltage Vqb can be continuously maintained at a high level, as indicated by the reference numeral Y2 in FIG. 15.

Next, when the third node voltage Va becomes a low level, the 4a-th transistor T4a and the 4b-th transistor T4b can be turned off, and in this case, the QB node QB can maintain the level of the previous state.

For example, if the third node voltage Va becomes a low level in the second period A2, the QB node voltage Vqb in the second period A2 can become the same high level as the QB node voltage Vqb in the first period A1. In addition, if the third node voltage Va becomes a low level in the tenth period A10, the QB node voltage Vqb in the tenth period A10 can become the same high level as the QB node voltage Vqb in the ninth period A9. In addition, when the third node voltage Va becomes a low level in the twelfth period A12, the QB node voltage Vqb in the twelfth period A12 can become the same high level as the QB node voltage Vqb in the eleventh period A11.

Next, during a period in which the Q node voltage Vq is high level, the 5a-th transistor T5a and the 5b-th transistor T5b can be turned on, and during this period, the QB node voltage Vqb can be maintained at a low level.

Through the above-described processes, a voltage of a level opposite to that of the Q node Q can be supplied to the QB node QB. That is, the QB node voltage Vqb can have a form in which the Q node voltage Vq is inverted.

Next, when the 4a-th transistor T4a, the 4b-th transistor T4b, the 5a-th transistor T5a, and the 5b-th transistor T5b are turned off (i.e., when the gate-source voltage Vgs of each transistor becomes 0V), the QB node QB should maintain the previous state.

However, when the threshold voltage Vth of the 4a-th transistor T4a, the 4b-th transistor T4b, the 5a-th transistor T5a, and the 5b-th transistor T5b become negative voltages, the difference voltage obtained by subtracting the threshold voltage Vth from the gate-source voltage Vgs can be greater than 0, and accordingly, the 4b-th transistor T4b and the 5b-th transistor T5b may not be completely turned off.

To prevent or suppress this, the 4m-th transistor T4m and the 5m-th transistor T5m can be turned on when the QB node QB is at the high level to maintain the second node NT2 and the fourth node NT4 at the high level.

Accordingly, the gate-source voltage Vgs of the 4b-th transistor T4b and the 5b-th transistor T5b can be a value less than 0V, and accordingly, the 4b-th transistor T4b and the 5b-th transistor T5b can be completely turned off.

Therefore, the charge of the QB node QB cannot be leaked through the 4b-th transistor T4b and the 5b-th transistor T5b. Accordingly, the QB node QB can be continuously maintained at a high level from the ninth period A9 until the third period A3 starts again.

That is, the 4m-th transistor T4m and the 5m-th transistor T5m can perform a memory function for maintaining the previous state.

Finally, the characteristics of the inverting unit 220 are summarized as follows.

The discharge control unit 222 constituting the inverting unit 220 can be connected to the second terminal of the 4m-th transistor T4m of the charge control unit 221 constituting the inverting unit 220, the QB node QB, the Q node Q, and the first low voltage line 1LVL to which the first low voltage VSS is supplied.

The charging control unit 221 can change the QB node voltage Vqb to a high level, charge the QB node voltage Vqb to the QB node QB, and maintain the QB node voltage Vqb at a high level until the QB node voltage Vqb is changed to a low level by the discharge control unit 222.

For example, from the time when the QB node voltage Vqb is changed to a high level in the ninth period A9 until the QB node voltage Vqb is changed to a low level by the discharge control unit 222 in the third period A3, current leakage at the QB node QB can be prevented or suppressed by the 4m-th transistor T4m of the charge control unit 221. Accordingly, the QB node voltage Vqb can be continuously and stably maintained at the high level. In this case, the 5m-th transistor T5m of the discharge control unit 222 can also prevent or suppress current leakage at the QB node QB together with the 4m-th transistor T4m.

The charging control unit 221 can be connected to the first terminal of the 5m-th transistor T5m of the discharge control unit 222, the QB node QB, the first low voltage line 1LVL, the start signal line STL to which the start signal VST is supplied, and the start unit 210.

The discharge control unit 222 can change the QB node voltage Vqb to a low level when the Q node voltage Vq is changed to a high level.

For example, when the 5b-th transistor T5b and the 5a-th transistor T5a are turned on by the high-level Q node voltage Vq, the first low voltage VSS having a low level can be supplied to the QB node QB through the 5b-th transistor T5b and the 5a-th transistor T5a. Accordingly, the high-level QB node voltage Vqb can be discharged through the 5a-th transistor T5a and the 5b-th transistor T5b.

Therefore, the discharge control unit 222 can change the QB node voltage Vqb to a low level opposite to the high-level Q node voltage Vq.

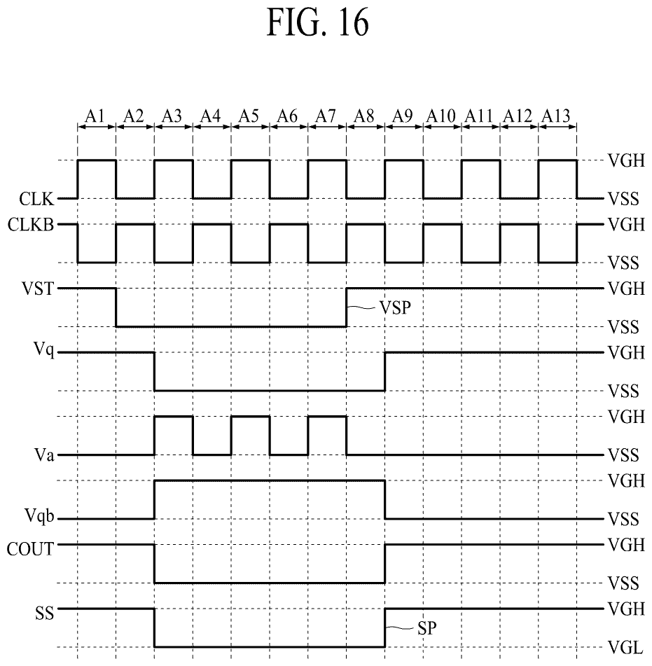

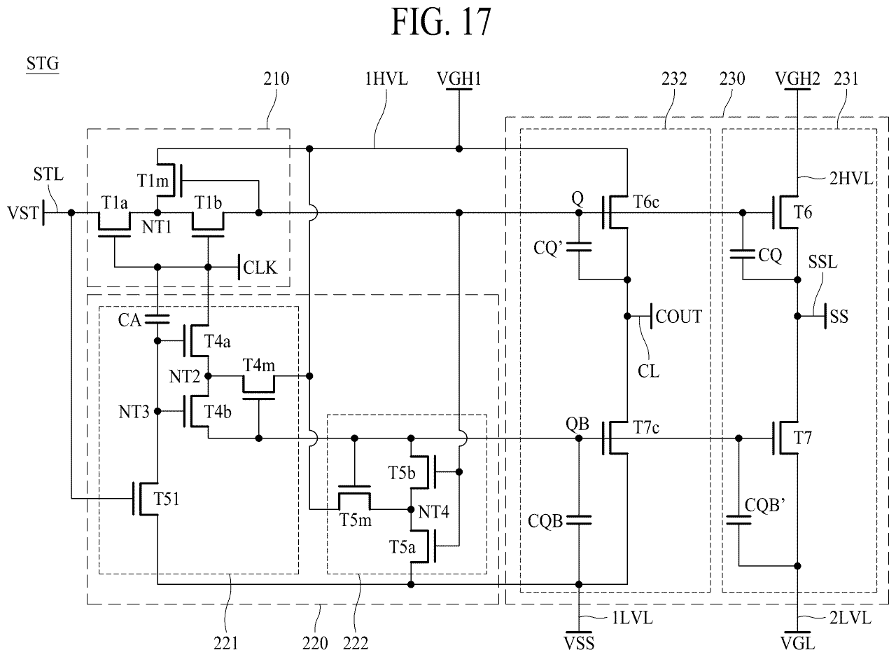

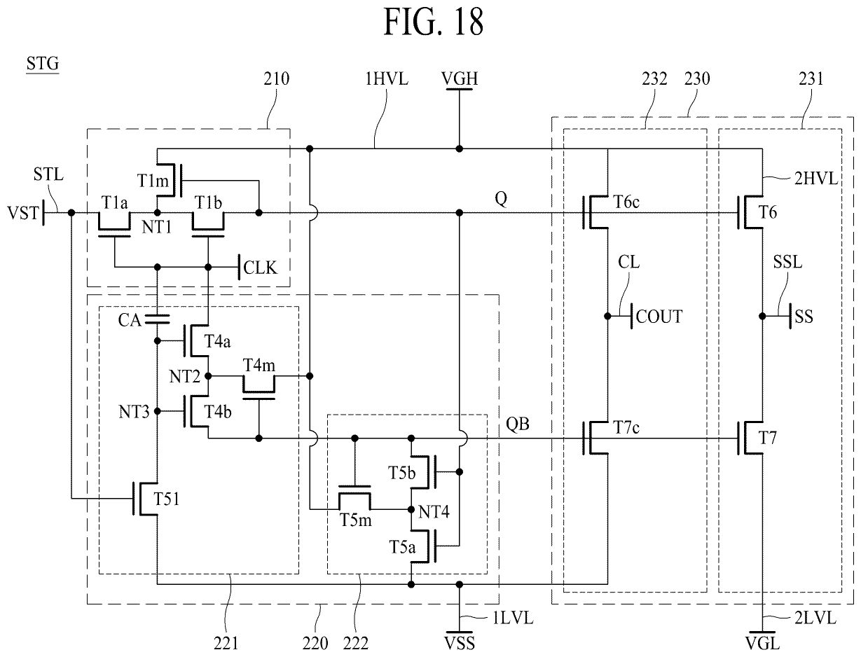

FIG. 16 is another example diagram illustrating signals supplied to a stage applied to a light emitting display apparatus according to an example embodiment of the present disclosure and signals generated from the stage, and FIGS. 17 and 18 are other example diagrams illustrating the structure of a stage applied to a light emitting display apparatus according to an example embodiment of the present disclosure.

As described above, according to the light emitting display apparatus according to an example embodiment of the present disclosure, a scan pulse SP having a pulse width equal to that of the start pulse VSP can be generated.

In this case, as illustrated in FIG. 7, a high-level scan pulse SP can be generated using a high-level start pulse VSP, and a low-level scan pulse SP can be generated using a low-level start pulse VSP, as illustrated in FIG. 16.

To increase the stability of the Q node voltage Vq and increase the stability of the QB node voltage Vqb, as illustrated in FIG. 17, a Q node capacitor CQ can be further connected between the Q node Q and the scan line SSL, a Q′ node capacitor CQ′ can be further connected between the Q node Q and the carry line CL, a QB node capacitor CQB can be further connected between the QB node QB and the first low voltage line 1LVL, and a QB′ node capacitor CQB′ can be further connected between the QB node QB and the second low voltage line 2LVL. The Q node capacitor CQ, Q′ node capacitor CQ′, QB node capacitor CQB, and QB′ node capacitor CQB′ can be included in the signal generation unit 230, as illustrated in FIG. 17.

In this case, at least one of the Q node capacitor CQ, the Q′ node capacitor CQ′, the QB node capacitor CQB, and the QB′ node capacitor CQB′ can be included in the signal generation unit 230.

The signal generation unit 230 can include a scan signal unit 231 and a carry signal unit 232.

The scan signal unit 231 can output the second high voltage VGH2 or the second low voltage VGL as a scan signal SS depending on the potentials of the Q node Q and the QB node QB.

The scan signal unit 231 can include a 6th transistor T6 and a 7th transistor T7.

The 6th transistor T6 is a pull-up switch of the scan signal unit 231, which is controlled depending on the Q node voltage Vq, and can output the second high voltage VGH2 as a scan signal SS when the Q node voltage Vq is at a high level.

The seventh transistor T7 is a pull-down switch of the scan signal unit 231, which is controlled according to the QB node voltage Vqb, and can output the second low voltage VGL as a scan signal SS when the QB node voltage Vqb is at a high level.

The carry signal unit 232 can output the first high voltage VGH1 or the first low voltage VSS as the carry signal COUT depending on the potentials of the Q node Q and the QB node QB, and the carry signal COUT can be the start signal VST of a rear stage.

The carry signal unit 232 can include a 6c-th transistor T6c and a 7c-th transistor T7c.

The 6c-th transistor T6c is a pull-up switch of the carry signal unit 232, which is controlled depending on the Q node voltage Vq, and can output the first high voltage VGH1 as the carry signal COUT when the Q node voltage Vq is at a high level.

The 7c-th transistor T7c is a pull-down switch of the carry signal unit 232, which is controlled depending on the QB node voltage Vqb, and can output the first low voltage VSS as the carry signal COUT when the QB node voltage Vqb is at a high level.

Also, in FIGS. 6A and 17, the first high voltage VGH1 can be greater than or equal to the second high voltage VGH2.

For example, as the first high voltage VGH1 is higher than the second high voltage VGH2, the second high voltage VGH2 can be output faster.

However, the stage STG can operate normally even under the same condition that the first high voltage VGH1 is the same as the second high voltage VGH2, and the stage STG can be formed in a more concise structure.

Therefore, as illustrated in FIG. 18, the same level of high voltage VGH can be supplied to the 6c-th transistor T6c and the 6th transistor T6.

Also, the first low voltage VSS can be less than or equal to the second low voltage VGL.

For example, when the first low voltage VSS is a voltage lower than the second low voltage VGL, because the 7th transistor T7 can be completely turned off (Vgs=VSS−VGL<<0), the second high voltage VGH2 can be accurately output through the scan line SSL.

Accordingly, an appropriate high voltage and low voltage can be set depending on the negative (−) shift degree of the threshold voltage of the transistors, so that the driving margin of the light emitting display apparatus can be secured and the power consumption of the light emitting display apparatus can be reduced.

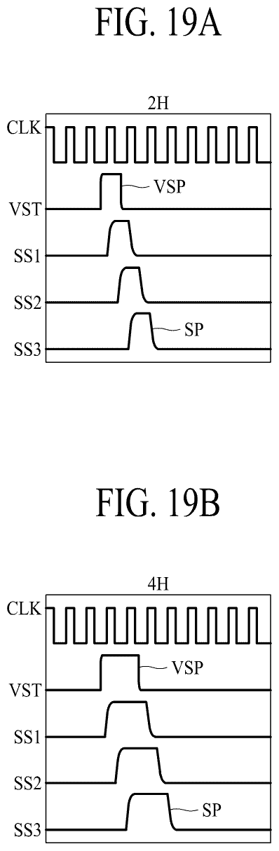

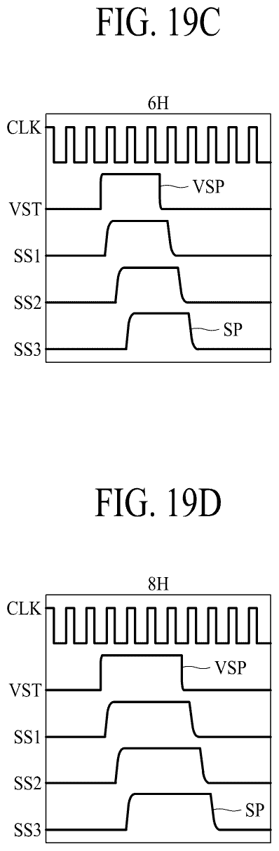

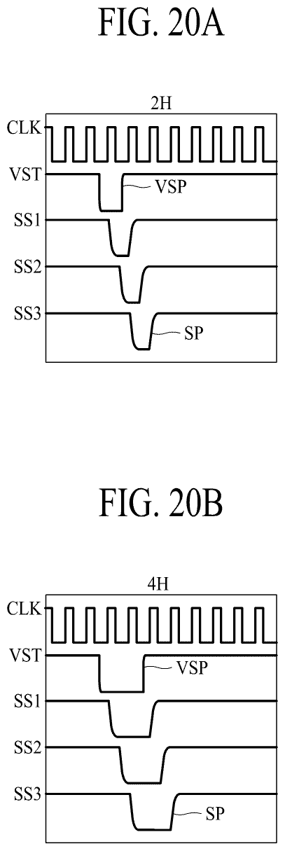

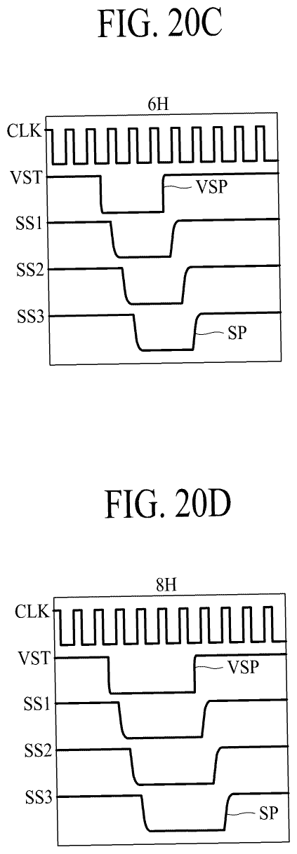

FIGS. 19A to 19D and 20A to 20D are example diagrams illustrating start signals and scan signals applied to a light emitting display apparatus according to an example embodiment of the present disclosure.

As described above, according to the light emitting display apparatus according to an example embodiment of the present disclosure, the pulse width of the scan pulse SP can be changed by the pulse width of the start pulse VSP.

For example, when the pulse width of the clock CLK is 1 H, a high-level first scan signal SS1, a high-level second scan signal SS2, and a high-level third scan signal SS3 having a pulse width of 2 H can be sequentially output from the stages STG by a high-level start pulse VSP having a pulse width of 2 H, as illustrated in FIG. 19A, a high-level first scan signal SS1, a high-level second scan signal SS2, and a high-level third scan signal SS3 having a pulse width of 4 H can be sequentially output from the stages STG by a high-level start pulse VSP having a pulse width of 4 H, as illustrated in FIG. 19B, a high-level first scan signal SS1, a high-level second scan signal SS2, and a high-level third scan signal SS3 having a pulse width of 6 H can be sequentially output from the stages STG by a high-level start pulse VSP having a pulse width of 6 H, as illustrated in FIG. 19C, and a high-level first scan signal SS1, a high-level second scan signal SS2, and a high-level third scan signal SS3 having a pulse width of 8 H can be sequentially output from the stages STG by a high-level start pulse VSP having a pulse width of 8 H, as illustrated in FIG. 19D.

In addition, as described with reference to FIG. 16, according to the light emitting display apparatus according to an example embodiment of the present disclosure, a low-level scan pulse SP can be generated using a low-level start pulse VSP.

For example, when the pulse width of the clock CLK is 1 H, a low-level first scan signal SS1, a low-level second scan signal SS2, and a low-level third scan signal SS3 having a pulse width of 2 H can be sequentially output from the stages STG by a low-level start pulse VSP having a pulse width of 2 H, as illustrated in FIG. 20A, a low-level first scan signal SS1, a low-level second scan signal SS2, and a low-level third scan signal SS3 having a pulse width of 4 H can be sequentially output from the stages STG by a low-level start pulse VSP having a pulse width of 4 H, as illustrated in FIG. 20B, a low-level first scan signal SS1, a low-level second scan signal SS2, and a low-level third scan signal SS3 having a pulse width of 6 H can be sequentially output from the stages STG by a low-level start pulse VSP having a pulse width of 6 H, as illustrated in FIG. 20C, and a low-level first scan signal SS1, a low-level second scan signal SS2, and a low-level third scan signal SS3 having a pulse width of 8 H can be sequentially output from the stages STG by a low-level start pulse VSP having a pulse width of 8 H, as illustrated in FIG. 20D.

Therefore, according to the light emitting display apparatus according to an example embodiment of the present disclosure, scan pulses SP having various pulse widths can be used without changing the structure of the gate driver 200.

The features of the light emitting display apparatus according to example embodiments of the present disclosure are briefly summarized as follows.

A light emitting display apparatus according to an example embodiment of the present disclosure comprises a light emitting display panel including pixels and stages configured to supply scan signals to the pixels, respectively, wherein each of the stages starts to be driven by a start pulse and outputs a scan pulse having a pulse width identical to a pulse width of the start pulse.

Each of the stages includes a start unit driven by a start signal including the start pulse and configured to generate a Q node voltage, an inverting unit configured to generate a QB node voltage opposite to the Q node voltage by using the start signal, and a signal generation unit configured to generate a scan signal and a carry signal by using the Q node voltage and the QB node voltage.

The signal generation unit includes a scan signal unit connected to a Q node to which the Q node voltage is supplied and to a QB node to which the QB node voltage is supplied, and configured to output a scan signal to a scan line, and a carry signal unit connected to the Q node and the QB node, and configured to output a carry signal used as a start signal in a rear stage.

The start unit includes a 1a-th transistor including a first terminal to which the start signal is supplied, a second terminal connected to a first node, and a gate to which a clock is supplied, a 1b-th transistor including a first terminal connected to the first node, a second terminal connected to the signal generation unit through a Q node, and a gate to which the clock is supplied, and a 1m-th transistor including a first terminal connected to the first node, a gate connected to the Q node, and a second terminal connected to a first high voltage line to which a first high voltage is supplied.

The gate of the 1a-th transistor and the gate of the 1b-th transistor are connected to the inverting unit.

A clock changes from a high level to a low level when the start signal changes from low level to high level, and the clock changes from a high level to a low level when the start signal changes from a high level to a low level.

The clock supplied to the start unit changes from a high level to a low level when the start signal changes from a low level to a high level, and changes from a high level to a low level when the start signal changes from a high level to a low level.

After the start pulse having a high level and a clock having a low level are supplied, when the clock changes from a low level to a high level, the start unit generates the Q node voltage having a high level and supplies the Q node voltage to the signal generation unit.

The start pulse having a high level supplied to the start unit and the Q node voltage having a high level output from the start unit have a phase difference equal to or greater than a pulse width of a clock supplied to the start unit.

The Q node voltage is continuously maintained at a high level when the start signal having a high level is blocked in the start unit.

The inverting unit includes a discharge control unit connected to a Q node to which the Q node voltage is supplied and to a QB node to which the QB node voltage is supplied, and configured to discharge the QB node voltage charged in the QB node, and a charge control unit connected to the start unit and the QB node, and configured to charge the QB node voltage into the QB node.

The charge control unit includes a 4a-th transistor including a first terminal to which a clock supplied to the start unit is supplied, a second terminal connected to a second node, and a gate connected to a third node, a 4b-th transistor including a first terminal connected to the second node, a second terminal connected to the QB node, and a gate connected to the third node, a 4m-th transistor including a first terminal connected to the second node, a gate connected to the QB node, and a second terminal connected to a first high voltage line to which a first high voltage is supplied, a 51-th transistor including a first terminal connected to the third node, a second terminal connected to a first low voltage line to which a first low voltage is supplied, and a gate connected to a start signal line to which the start signal is supplied, and a first capacitor including a first terminal to which the clock is supplied and a second terminal connected to the third node.

The discharge control unit is connected to the second terminal of the 4m-th transistor, the QB node, the Q node, and the first low voltage line to which the first low voltage is supplied.

When the QB node voltage changes to a high level, the charge control unit maintains the QB node voltage at a high level until the QB node voltage is changed to a low level by the discharge control unit.

The discharge control unit includes a 5b-th transistor including a first terminal connected to the QB node, a second terminal connected to a fourth node, and a gate connected to the Q node, a 5a-th transistor including a first terminal connected to the fourth node, a second terminal connected to a first low voltage line to which a first low voltage is supplied, and a gate connected to the Q node, and a 5m-th transistor including a first terminal connected to a first high voltage line to which a first high voltage is supplied, a second terminal connected to the fourth node, and a gate connected to the QB node.

The charge control unit is connected to the first terminal of the 5m-th transistor, the QB node, the first low voltage line, a start signal line to which the start signal is supplied, and the start unit.

The discharge control unit changes the QB node voltage to a low level when the Q node voltage changes to a high level.

The light emitting display apparatus according to an example embodiment of the present disclosure can be applied to all electronic devices including a light emitting display panel. For example, the light emitting display apparatus according to the present disclosure can be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display devices, televisions, wall paper display devices, signage devices, game devices, laptops, monitors, cameras, camcorders, and home appliances.

According to a light emitting display apparatus according to an example embodiment of the present disclosure, a pulse width of a scan pulse output from a stage of a gate driver can be the same as a pulse width of a start pulse supplied to the stage. Accordingly, a pulse width of a scan pulse can be variously changed by a pulse width of a start pulse.

Therefore, even if the pulse width of a scan pulse required by the light emitting display apparatus is changed, the structure of the stage need not be changed. Therefore, the manufacturing cost of the light emitting display apparatus can be reduced.

Furthermore, according to the light emitting display apparatus according to an example embodiment of the present disclosure, current leakage on the stage can be reduced. Therefore, power consumption of the light emitting display apparatus can be reduced.

The above-described feature, structure, and effect of the present disclosure are included in at least one example embodiment of the present disclosure, but are not limited to only one embodiment. Furthermore, the feature, structure, and effect described in at least one example embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A light emitting display apparatus, comprising:
a light emitting display panel including pixels; and
stages configured to supply scan signals to the pixels, respectively,
wherein each of the stages starts to be driven by a start pulse and outputs a scan pulse having a pulse width identical to a pulse width of the start pulse.

2. The light emitting display apparatus of claim 1, wherein each of the stages includes:
a start unit driven by a start signal including the start pulse and configured to generate a Q node voltage;
an inverting unit configured to generate a QB node voltage opposite to the Q node voltage by using the start signal; and
a signal generation unit configured to generate a scan signal and a carry signal by using the Q node voltage and the QB node voltage.

3. The light emitting display apparatus of claim 2, wherein the signal generation unit includes:
a scan signal unit connected to a Q node to which the Q node voltage is supplied and to a QB node to which the QB node voltage is supplied, and configured to output a scan signal to a scan line; and
a carry signal unit connected to the Q node and the QB node, and configured to output a carry signal used as a start signal in a rear stage.

4. The light emitting display apparatus of claim 2, wherein the start unit includes:
a 1a-th transistor including a first terminal to which the start signal is supplied, a second terminal connected to a first node, and a gate to which a clock is supplied;
a 1b-th transistor including a first terminal connected to the first node, a second terminal connected to the signal generation unit through a Q node, and a gate to which the clock is supplied; and
a 1m-th transistor including a first terminal connected to the first node, a gate connected to the Q node, and a second terminal connected to a first high voltage line to which a first high voltage is supplied.

5. The light emitting display apparatus of claim 4, wherein the gate of the 1a-th transistor and the gate of the 1b-th transistor are connected to the inverting unit.

6. The light emitting display apparatus of claim 4, wherein the clock changes from a high level to a low level when the start signal changes from low level to high level, and the clock changes from a high level to a low level when the start signal changes from a high level to a low level.

7. The light emitting display apparatus of claim 2, wherein a clock supplied to the start unit changes from a high level to a low level when the start signal changes from a low level to a high level, and changes from a high level to a low level when the start signal changes from a high level to a low level.

8. The light emitting display apparatus of claim 2, wherein after the start pulse having a high level and a clock having a low level are supplied, when the clock changes from a low level to a high level, the start unit generates the Q node voltage having a high level and supplies the Q node voltage to the signal generation unit.

9. The light emitting display apparatus of claim 2, wherein the start pulse having a high level supplied to the start unit and the Q node voltage having a high level output from the start unit have a phase difference equal to or greater than a pulse width of a clock supplied to the start unit.

10. The light emitting display apparatus of claim 2, wherein the Q node voltage is continuously maintained at a high level when the start signal having a high level is blocked in the start unit.

11. The light emitting display apparatus of claim 2, wherein the inverting unit includes:
a discharge control unit connected to a Q node to which the Q node voltage is supplied and to a QB node to which the QB node voltage is supplied, and configured to discharge the QB node voltage charged in the QB node; and
a charge control unit connected to the start unit and the QB node, and configured to charge the QB node voltage into the QB node.

12. The light emitting display apparatus of claim 11, wherein the charge control unit includes:
a 4a-th transistor including a first terminal to which a clock supplied to the start unit is supplied, a second terminal connected to a second node, and a gate connected to a third node;
a 4b-th transistor including a first terminal connected to the second node, a second terminal connected to the QB node, and a gate connected to the third node;
a 4m-th transistor including a first terminal connected to the second node, a gate connected to the QB node, and a second terminal connected to a first high voltage line to which a first high voltage is supplied;
a 51-th transistor including a first terminal connected to the third node, a second terminal connected to a first low voltage line to which a first low voltage is supplied, and a gate connected to a start signal line to which the start signal is supplied; and
a first capacitor including a first terminal to which the clock is supplied and a second terminal connected to the third node.

13. The light emitting display apparatus of claim 12, wherein the discharge control unit is connected to the second terminal of the 4m-th transistor, the QB node, the Q node, and the first low voltage line to which the first low voltage is supplied.

14. The light emitting display apparatus of claim 11, wherein when the QB node voltage changes to a high level, the charge control unit maintains the QB node voltage at a high level until the QB node voltage is changed to a low level by the discharge control unit.

15. The light emitting display apparatus of claim 11, wherein the discharge control unit includes:
a 5b-th transistor including a first terminal connected to the QB node, a second terminal connected to a fourth node, and a gate connected to the Q node;
a 5a-th transistor including a first terminal connected to the fourth node, a second terminal connected to a first low voltage line to which a first low voltage is supplied, and a gate connected to the Q node; and
a 5m-th transistor including a first terminal connected to a first high voltage line to which a first high voltage is supplied, a second terminal connected to the fourth node, and a gate connected to the QB node.

16. The light emitting display apparatus of claim 15, wherein the charge control unit is connected to the first terminal of the 5m-th transistor, the QB node, the first low voltage line, a start signal line to which the start signal is supplied, and the start unit.

17. The light emitting display apparatus of claim 11, wherein the discharge control unit changes the QB node voltage to a low level when the Q node voltage changes to a high level.
